(19) United States
(12) Patent Application Publication
(10) Pub. No.: US 2016/0187743 A1
(43) Pub. Date: Jun. 30, 2016

(54) PIXEL STRUCTURE OF TRANSPARENT LIQUID CRYSTAL DISPLAY PANEL

(71) Applicant: AU Optronics Corp., Hsin-Chu (TW)

(72) Inventors: Chia-Wei Kuo, Hsin-Chu (TW); Yi-Yang Liao, Hsin-Chu (TW); Ching-Huan Lin, Hsin-Chu (TW); Ting-Wei Guo, Hsin-Chu (TW); Kun-Ying Hsin, Hsin-Chu (TW); Bo-Shiang Tzeng, Hsin-Chu (TW); Kang-Hung Liu, Hsin-Chu (TW); Jen-Kuei Lu, Hsin-Chu (TW); Norio Sugiura, Hsin-Chu (TW)

(21) Appl. No.: 15/065,838

(22) Filed: Mar. 9, 2016

Related U.S. Application Data
(62) Division of application No. 13/902,844, filed on May 26, 2013.

(30) Foreign Application Priority Data
Oct. 12, 2012 (TW) 101137868

(51) Int. Cl. G02F 1/1343; G02F 1/1337

(52) U.S. Cl. CPC G02F 1/134309; G02F 1/133707; G02F 2001/134345; G02F 2001/133742

(57) ABSTRACT

A pixel structure of a transparent LCD panel includes a pixel and liquid crystal molecules. The pixel includes a white sub-pixel and a color sub-pixel. In a transparent display mode, a first alignment region and a second alignment region of the white sub-pixel and a first alignment region and a second alignment region of the color sub-pixel have a transparent display grayscale, and a third alignment region and a fourth alignment region of the color sub-pixel have a non-transparent display grayscale. In an image display mode, the first alignment region and the second alignment region of the white sub-pixel have the non-transparent display grayscale, and the first alignment region, the second alignment region, the third alignment region and the fourth alignment region of the color sub-pixel have an image display grayscale.

### CROSS REFERENCE TO RELATED APPLICATIONS

This application is a division of U.S. application Ser. No. 13/902,844 filed on May 26, 2013, and incorporated herein by reference in its entirety.

### BACKGROUND OF THE INVENTION

1. Field of the Invention

The present invention relates to a pixel structure of a transparent liquid crystal display panel, and more particularly, to a pixel structure of a transparent liquid crystal display panel having high light transmittance and able to avoid background image blur problem.

2. Description of the Prior Art

Due to the advantage of compact size, liquid crystal display (LCD) panel has been broadly applied in various types of electronic products such as smart phone, personal digital assistant (PDA) and notebook computer. The LCD panel, however, suffers from its disadvantage of narrow viewing angle, which limits the development of LCD panel. To overcome the narrow viewing angle issue, a multi-domain vertical alignment (MVA) LCD has been proposed.

The pixel structure of an MVA LCD panel includes a plurality of alignment regions of different aligning directions, which gives wide viewing angle feature. The MVA LCD panel, however, when applying in a transparent LCD panel which can be switched between a transparent display mode and an image display mode, the arrangement of liquid crystal molecules in the plurality of alignment regions tends to cause diffraction of light. Thus, the MVA LCD panel suffers from background image blur problem in the transparent display mode. In addition, the color saturation of image is reduced under the influence of background light in the image display mode.

### SUMMARY OF THE INVENTION

It is therefore one of the objectives of the present invention to provide a pixel structure of a transparent liquid crystal display panel to solve background image blur problem.

According to an embodiment, a pixel structure of a transparent liquid crystal display panel is provided. The pixel structure of the transparent liquid crystal display panel includes an array substrate, a gate line, a data line, a pixel electrode, a counter substrate, a common electrode and a plurality of liquid crystal molecules. The gate line and the data line are disposed on the array substrate. The pixel consists of at least one first alignment region and at least one second alignment region, wherein the first alignment region and the second alignment region of the pixel have different aligning directions. The pixel electrode is disposed on the array substrate and in the pixel. The pixel electrode comprises at least one main electrode disposed between the first alignment region and the second alignment region, and a plurality of branch electrodes, wherein the at least one main electrode is substantially a bar-shaped electrode, a portion of the branch electrodes are connected to one side of the at least one main electrode and extending along a first direction to be disposed in the first alignment region, the other portion of the branch electrodes are connected to the other side of the at least one main electrode and extending along a second direction to be disposed in the second alignment region, and the first direction and the second direction are substantially opposite and in parallel. A slit is formed between two adjacent branch electrodes, and an included angle between the first direction and the gate line is substantially between 35 degrees and 55 degrees. The counter substrate faces the array substrate. The common electrode is disposed on the counter substrate. The liquid crystal molecules are disposed between the array substrate and the counter substrate.

According to another embodiment, a pixel structure of a transparent liquid crystal display panel is provided. The pixel structure of the transparent liquid crystal display panel includes an array substrate, a pixel and a plurality of liquid crystal molecules. The pixel includes a white sub-pixel and a color sub-pixel. The white sub-pixel consists of a first alignment region and a second alignment, the first alignment region and the second alignment region of the white sub-pixel having different aligning directions. The color sub-pixel comprises a first alignment region, a second alignment region, a third alignment region and a fourth alignment region, and the first alignment region, the second alignment region, the third alignment region and the fourth alignment region of the color sub-pixel have different aligning directions. The first alignment region of the color sub-pixel and the first alignment region of the white sub-pixel have substantially the same aligning direction, the second alignment region of the color sub-pixel and the second alignment region of the white sub-pixel have substantially the same aligning direction, and the third alignment region and the fourth alignment region of the color sub-pixel and the first alignment region and the second alignment region of the white sub-pixel have different aligning directions. The liquid crystal molecules are disposed in the pixel. In a transparent display mode, the first alignment region and the second alignment region of the white sub-pixel and the first alignment region and the second alignment region of the color sub-pixel have a transparent display grayscale, and the third alignment region and the fourth alignment region of the color sub-pixel have a non-transparent display grayscale. In an image display mode, the first alignment region and the second alignment region of the white sub-pixel have the non-transparent display grayscale, and the first alignment region, the second alignment region, the third alignment region and the fourth alignment region of the color sub-pixel have an image display grayscale, respectively, based on an image to be displayed.

According to still another embodiment, a pixel structure of a transparent liquid crystal display panel is provided. The pixel structure of the transparent liquid crystal display panel includes an array substrate, a pixel and a plurality of liquid crystal molecules. The pixel comprises a first alignment region and a second alignment region. The liquid crystal molecules are disposed in the pixel. In a transparent display mode, the liquid crystal molecules disposed in the first alignment region and the second alignment region have substantially the same aligning direction. In an image display mode, the liquid crystal molecules disposed in the first alignment region and the second alignment region have different aligning directions.

According to yet another embodiment, a pixel structure of a transparent liquid crystal display panel is provided. The pixel structure of the transparent liquid crystal display panel includes a plurality of pixels and a plurality of active switching devices. Each of the pixels comprises a first sub-pixel configured to provide a first display image, and a second sub-pixel configured to provide a second display image. A color space coverage of the first display image is higher than a color space coverage of the second display image. The active switching devices are configured to control the first sub-pixel and the second sub-pixel, respectively. In a transparent display mode, the first sub-pixel and the second sub-pixel of each of the pixels have a transparent display grayscale. In an image display mode, the first sub-pixel of each of the pixel has an image display grayscale based on an image to be displayed, and the second sub-pixel of each of the pixels has a non-transparent display grayscale.

According to another embodiment, a pixel structure of a transparent liquid crystal display panel is provided. The pixel structure of the transparent liquid crystal display panel includes a first pixel and a second pixel. The first pixel is disposed in a display region for providing a first display image. The second pixel is disposed in a transparent region for providing a second display image. A color space coverage of the first display image is higher than a color space coverage of the second display image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram of a pixel structure of a transparent liquid crystal display panel according to a first embodiment of the present invention.

FIG. 2 is a schematic top view of a pixel structure of a transparent liquid crystal display panel according to a first embodiment of the present invention.

FIG. 3 schematically illustrates an array substrate of a pixel structure of a transparent LCD panel according to a first variant embodiment of the first embodiment.

FIG. 4 schematically illustrates a counter substrate of a pixel structure of a transparent LCD panel according to a first variant embodiment of the first embodiment.

FIG. 5 schematically illustrates an array substrate of a pixel structure of a transparent LCD panel according to a second variant embodiment of the first embodiment.

FIG. 6 schematically illustrates a counter substrate of a pixel structure of a transparent LCD panel according to a second variant embodiment of the first embodiment.

FIG. 7 schematically illustrates an array substrate of a pixel structure of a transparent LCD panel according to a third variant embodiment of the first embodiment.

FIG. 8 schematically illustrates a counter substrate of a pixel structure of a transparent LCD panel according to a third variant embodiment of the first embodiment.

FIG. 9 is a schematic diagram illustrating a pixel structure of a transparent liquid crystal display panel according to another variant embodiment of a first embodiment of the present invention.

FIG. 10 is a schematic diagram illustrating a pixel structure of a transparent liquid crystal display panel according to still another variant embodiment of a first embodiment of the present invention.

FIG. 11 is a schematic diagram illustrating a pixel electrode of a pixel structure of a transparent LCD panel of a second embodiment of the present invention.

FIG. 12 is a schematic diagram illustrating a pixel structure of a transparent LCD panel of a second embodiment of the present invention in an image display mode.

FIG. 13 is a schematic diagram illustrating a pixel structure of a transparent LCD panel of a second embodiment of the present invention in a transparent display mode.

FIG. 14 is a schematic diagram illustrating a pixel electrode of a pixel structure of a transparent LCD panel of a variant embodiment of a second embodiment of the present invention.

FIG. 15 is a schematic diagram illustrating a pixel structure of a transparent LCD panel of a variant embodiment of a second embodiment of the present invention.

FIG. 16 is a schematic diagram of a pixel structure of a transparent LCD panel according to a third embodiment of the present invention.

FIG. 17 is a schematic diagram illustrating a pixel structure of a transparent LCD panel of a third embodiment of the present invention in an image display mode.

FIG. 18 is a schematic diagram illustrating a pixel structure of a transparent LCD panel of a third embodiment of the present invention in a transparent display mode.

FIG. 19 is a schematic diagram illustrating a pixel structure of a transparent LCD panel of a fourth embodiment of the present invention.

FIG. 20 depicts several different configurations of a pixel structure of a transparent LCD panel of this embodiment.

FIG. 21 depicts several other different configurations of a pixel structure of a transparent LCD panel of this embodiment.

FIG. 22 illustrates a relation between NTSC color space coverage and an area ratio of white sub-pixel to pixel.

FIG. 23 is a schematic diagram illustrating a pixel structure of a transparent LCD panel of a variant embodiment of a fourth embodiment of the present invention.

FIG. 24 illustrates a relation between NTSC color space coverage and thickness of color filter.

FIG. 25 is a schematic diagram illustrating a pixel structure of a transparent LCD panel of a fifth embodiment of the present invention.

FIG. 26 is a schematic diagram illustrating a pixel structure of a transparent LCD panel of a first variant embodiment of a fifth embodiment of the present invention.

FIG. 27 is a schematic diagram illustrating a pixel structure of a transparent LCD panel of a second variant embodiment of a fifth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

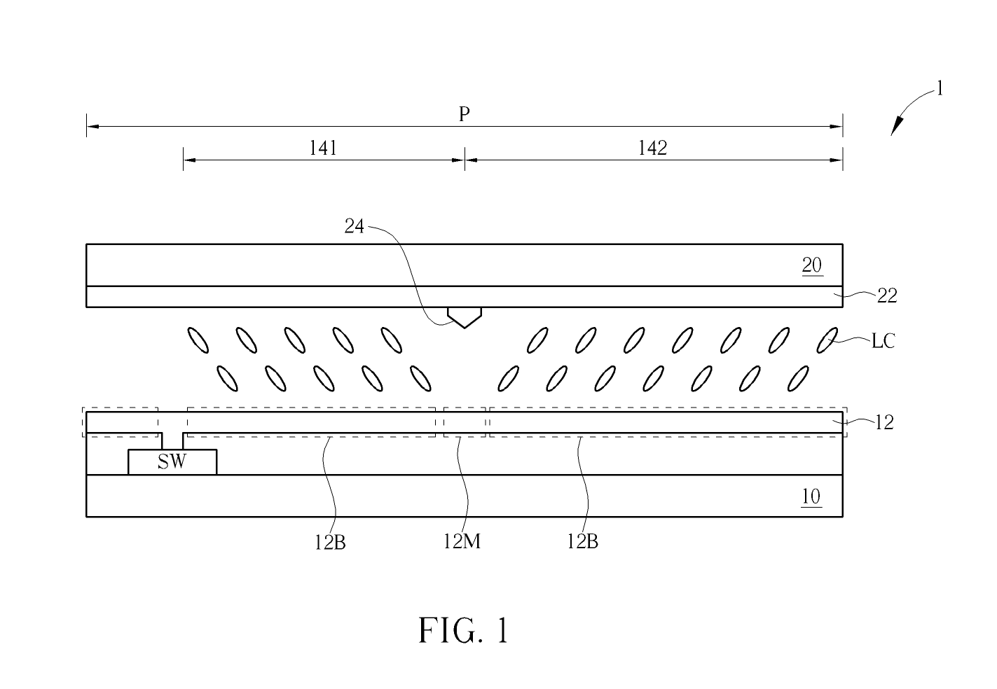

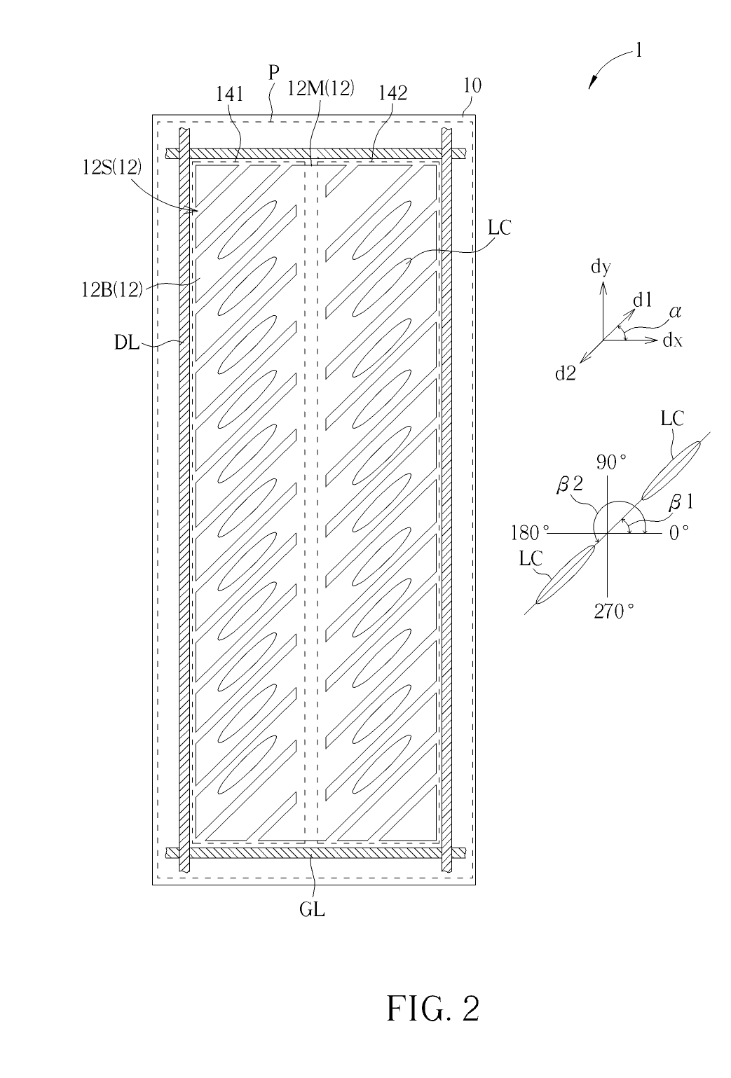

Please refer to FIG. 1 and FIG. 2. FIG. 1 is a schematic cross-sectional diagram of a pixel structure of a transparent liquid crystal display panel according to a first embodiment of the present invention, and FIG. 2 is a schematic top view of a pixel structure of a transparent liquid crystal display panel according to a first embodiment of the present invention. As shown in FIG. 1 and FIG. 2, the pixel structure 1 of the transparent LCD panel of this embodiment includes an array substrate 10, a gate line GL, a data line DL, an active switching device SW, a pixel electrode 12, a counter substrate 20, a common electrode 22 and liquid crystal molecules LC. The counter substrate 20 faces the array substrate 10, and the liquid crystal molecules LC are interposed between the array substrate 10 and the counter substrate 20. The liquid crystal molecules LC include vertically-aligned mode (VA mode) liquid crystal molecules, but not limited thereto. The gate line GL, the data line DL, the active switching device SW and the pixel electrode 12 are disposed on the array substrate 10. The gate line GL is disposed along a first extension direction dx, the data line DL is disposed along a second extension direction dy, and the gate line GL and the data line DL are substantially intersected perpendicularly, thereby defining a pixel P. The active switching device SW may be, for example, a thin film transistor device, but not limited thereto. The gate electrode is electrically connected to the gate line GL, the source electrode is electrically connected to the data line DL, and the drain electrode is electrically connected to the pixel electrode 12. The pixel electrode 12 may include a transparent electrode e.g. an indium tin oxide (ITO) electrode, but not limited thereto. The pixel P consists of at least one first alignment region 141 and at least one second alignment region 142, and the first alignment region 141 and the second alignment region 142 of the pixel P have different aligning directions. The pixel P does not includes any alignment region of another aligning direction different from that of the first alignment region 141 and that of the second alignment region 142. The common electrode 22 is disposed on the counter substrate 20. The common electrode 22 may include a transparent electrode e.g. an ITO electrode, but not limited thereto. The pixel structure 1 of the transparent LCD panel of this embodiment may further include other necessary devices (not shown) for implementing its display function such as alignment film, polarizer, color filter, light-shielding layer, storage capacitor line, etc, and the function and arrangement of the aforementioned devices are known and not redundantly described.

The pixel electrode 12 is disposed in the pixel P, and the pixel electrode 12 includes at least one main electrode 12M disposed between the first alignment region 141 and the second alignment region 142, and a plurality of branch electrodes 12B. The main electrode 12M is substantially a bar-shaped electrode. In this embodiment, the main electrode 12M and the data line DL are arranged in parallel manner, i.e. the main electrode 12M and the data line DL are disposed substantially in parallel. A portion of the branch electrodes 12B are connected to one side of the main electrode 12M and extending along a first direction d1 to be disposed in the first alignment region 141, and the other portion of the branch electrodes 12B are connected to the other side of the main electrode 12M and extending along a second direction d2 to be disposed in the second alignment region 142. In addition, a slit 12S is formed between any two adjacent branch electrodes 12B, where the slit 12S disposed in the first alignment region 141 is disposed along the first direction d1, and the slit 12S disposed in the second alignment region 142 is disposed along the second direction d2. The first direction d1 and the second direction d2 are substantially opposite and in parallel, and an included angle α between the first direction d1 and the first extension direction dx of the gate line GL is substantially between 35 degrees and 55 degrees i.e. between 45±10 degrees, but not limited thereto. In this embodiment, the main electrode 12M is substantially parallel to the second extension direction dy of the data line DL, but not limited thereto. Also, the difference between an azimuth angle 131 of a long axis of the liquid crystal molecules LC disposed in the first alignment region 141 and an azimuth angle β2 of a long axis of the liquid crystal molecules LC disposed in the second alignment region 142 is substantially 180 degrees, as shown in FIG. 2. In addition, to improve the aligning effect on the liquid crystal molecules LC, the pixel structure 1 of the transparent LCD panel may optionally include a protrusion structure 24 disposed on the counter substrate 20 and corresponding to the main electrode 12M.

The pixel structure 1 of the transparent LCD panel of this embodiment only includes the first alignment region 141 and the second alignment region 142, which means the liquid crystal molecules LC are aligned only along the first direction d1 and the second direction d2. Consequently, the background image blur problem due to too many alignment regions will not occur. As a result, the viewer can see clear and distinct images from the front side of the pixel structure 1 of the transparent LCD panel of this embodiment, i.e. display quality in a transparent display mode is improved. In addition, since the first direction d1 and the second direction d2 are substantially opposite and in parallel, and the first alignment region 141 and the second alignment region 142 are substantially equal in size, the pixel structure 1 of the transparent LCD panel of this embodiment has symmetrical viewing angle.

The pixel structure of the transparent LCD panel is not limited by the aforementioned embodiment, and may have other different embodiments. To simplify the description, the identical components in each of the following embodiments are marked with identical symbols. For making it easier to compare the difference between the embodiments, the following description will detail the dissimilarities among different embodiments and the identical features will not be redundantly described.

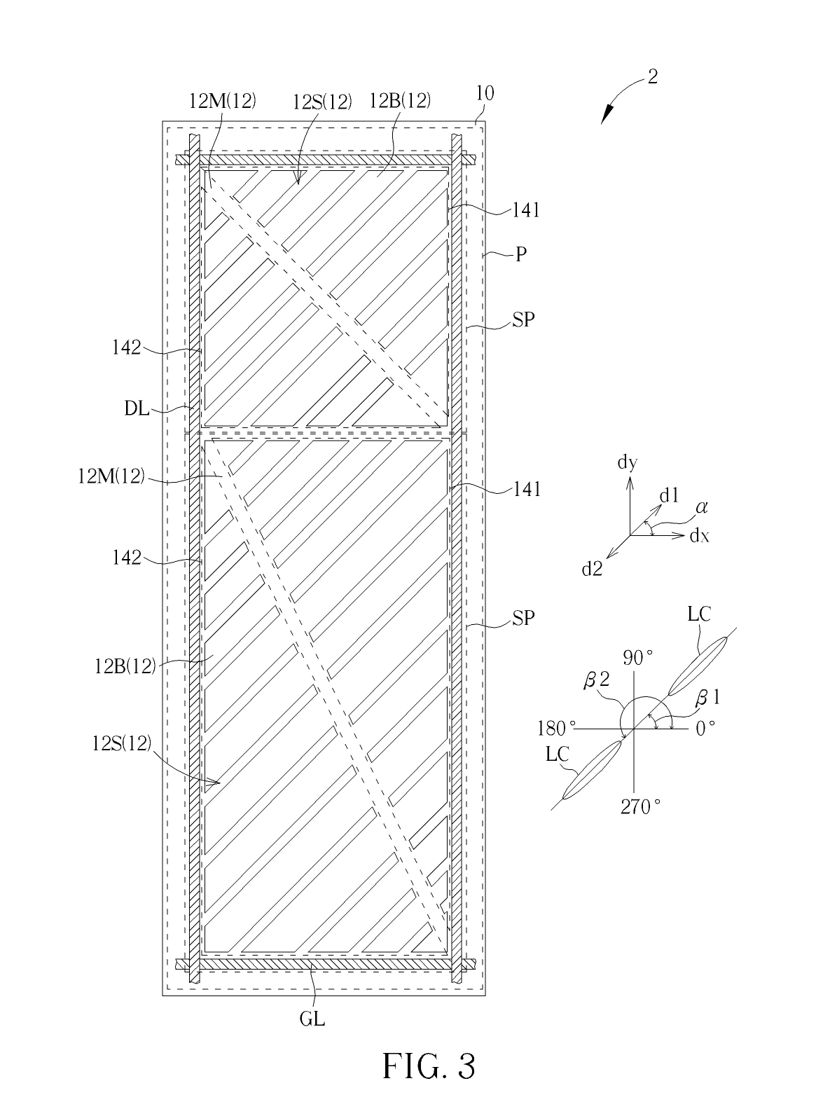

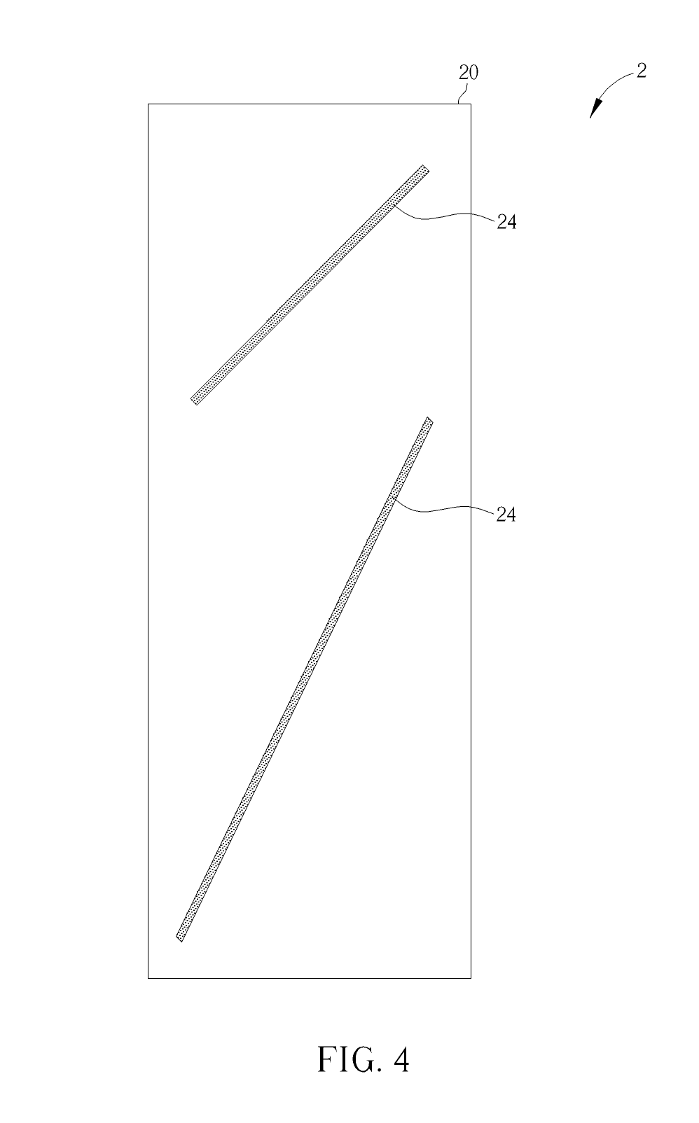

Please refer to FIG. 3 and FIG. 4, as well as FIG. 1. FIG. 3 schematically illustrates an array substrate of a pixel structure of a transparent LCD panel according to a first variant embodiment of the first embodiment, and FIG. 4 schematically illustrates a counter substrate of a pixel structure of a transparent LCD panel according to a first variant embodiment of the first embodiment. As shown in FIG. 3, in the pixel structure 2 of the transparent LCD panel of the first variant embodiment, the pixel P includes a plurality of sub-pixels SP, each sub-pixel SP consists of the first alignment region 141 and the second alignment region 142, and a plurality of main electrodes 12M are disposed in the sub-pixels SP, respectively. Each of the main electrodes 12M is disposed along a diagonal line of the corresponding sub-pixel SP, i.e. each of the main electrodes 12M and the data line DL are arranged in non-parallel and non-perpendicular manner. In addition, at least a portion of the sub-pixels SP have different areas, and at least a portion of the main electrodes 12M are arranged in non-parallel manner. For example, in the first variant embodiment, the pixel P includes two sub-pixels SP unequal in size, where one of the sub-pixels SP is substantially square in shape, while the other sub-pixel SP is substantially rectangular in shape. The main electrode 12M is disposed diagonally in the corresponding sub-pixel SP. Since these two sub-pixels SP are not equal in size, these two main electrodes 12M are not disposed in parallel. The included angle between the main electrode 12M and the branch electrode 12B is greater than zero degree and less than 180 degrees depending on the area of the sub-pixel SP. Each sub-pixel SP is divided into the first alignment region 141 and the second alignment region 142 by the main electrode 12M. In the first alignment region 141 of all the sub-pixels SP, the branch electrodes 12B and the slits 12S are all disposed along the first direction d1, and in the second alignment region 142 of all the sub-pixels SP, the branch electrodes 12B and the slits 12S are all disposed along the second direction d2. The difference between an azimuth angle β1 of a long axis of the liquid crystal molecules LC disposed in the first alignment region 141 and an azimuth angle β2 of a long axis of the liquid crystal molecules LC disposed in the second alignment region 142 is substantially 180 degrees, as shown in FIG. 3. Furthermore, the pixel electrodes 12 disposed in different sub-pixels SP may be connected directly or indirectly via other conducting wire (not shown). As shown in FIG. 4, to improve the aligning effect on the liquid crystal molecules LC, the pixel structure 2 of the transparent LCD panel may optionally include a plurality of protrusion structures 24 disposed on the counter substrate 20 and corresponding to the main electrodes 12M, respectively.

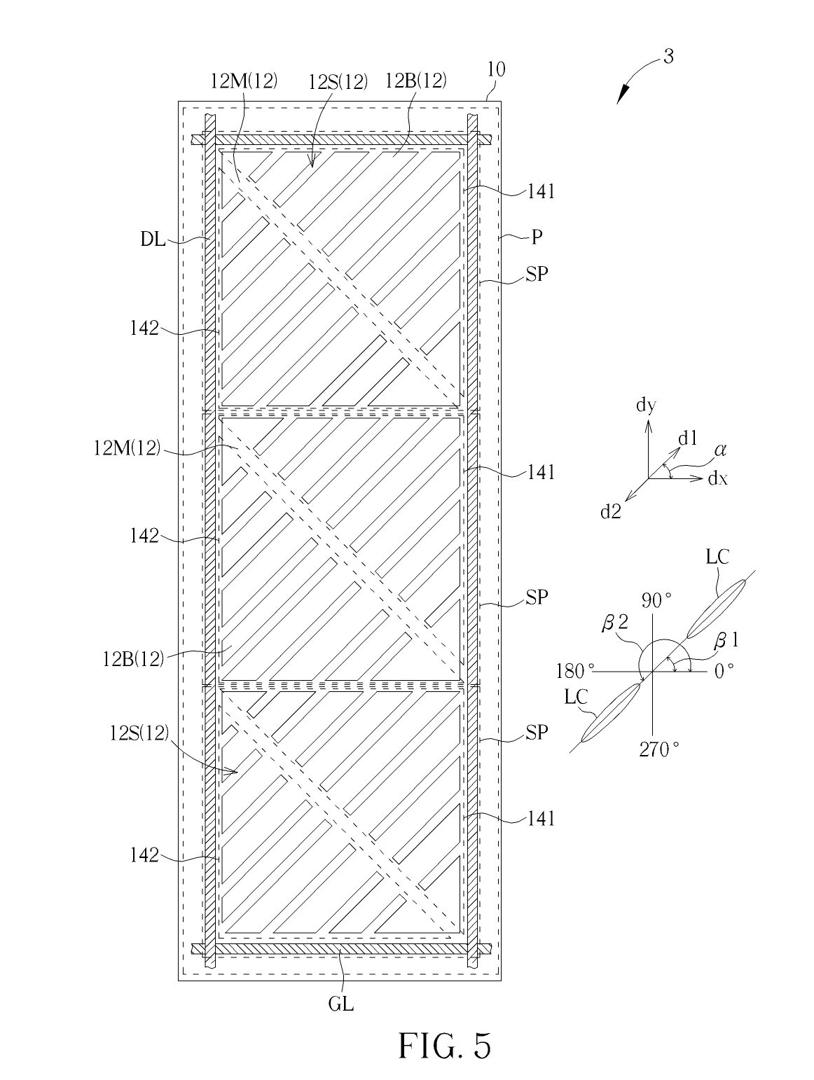

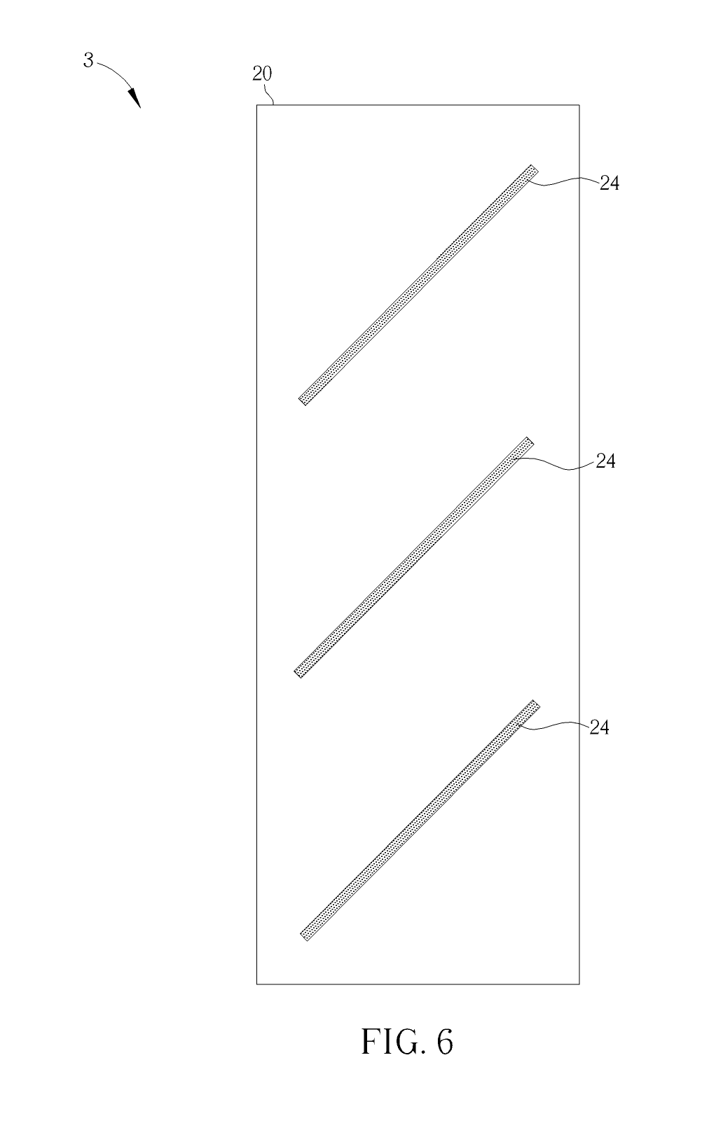

Please refer to FIG. 5 and FIG. 6, as well as FIG. 1. FIG. 5 schematically illustrates an array substrate of a pixel structure of a transparent LCD panel according to a second variant embodiment of the first embodiment, and FIG. 6 schematically illustrates a counter substrate of a pixel structure of a transparent LCD panel according to a second variant embodiment of the first embodiment. As shown in FIG. 5, in the pixel structure 3 of the transparent LCD panel of the second variant embodiment, the pixel P includes a plurality of sub-pixels SP, each sub-pixel SP consists of the first alignment region 141 and the second alignment region 142, and a plurality of main electrodes 12M are disposed in the sub-pixels SP, respectively. Each of the main electrodes 12M is disposed along a diagonal line of the corresponding sub-pixel SP, the sub-pixels SP have the area, and the main electrodes 12M are disposed in parallel. For example, in the second variant embodiment, the pixel P includes three sub-pixels SP which are all equal in size, and each sub-pixel SP is substantially square in shape. The main electrode 12M is disposed diagonally in the corresponding sub-pixel SP. Since these three sub-pixels SP are equal in size, these three main electrodes 12M are disposed in parallel, and the included angle between the main electrode 12M and the gate line GL is substantially equal to 45 degrees. In addition, each sub-pixel SP is divided into the first alignment region 141 and the second alignment region 142 by the main electrode 12M. In the first alignment region 141 of all the sub-pixels SP, the branch electrodes 12B and the slits 12S are all disposed along the first direction d1, and in the second alignment region 142 of all the sub-pixels SP, the branch electrodes 12B and the slits 12S are all disposed along the second direction d2. The difference between an azimuth angle β1 of a long axis of the liquid crystal molecules LC disposed in the first alignment region 141 and an azimuth angle β2 of a long axis of the liquid crystal molecules LC disposed in the second alignment region 142 is substantially 180 degrees, as shown in FIG. 5. Furthermore, the pixel electrodes 12 disposed indifferent sub-pixels SP may be connected directly or indirectly via other conducting wire (not shown). As shown in FIG. 6, to improve the aligning effect on the liquid crystal molecules LC, the pixel structure 3 of the transparent LCD panel may optionally include a plurality of protrusion structures 24 disposed on the counter substrate 20 and corresponding to the main electrodes 12M, respectively.

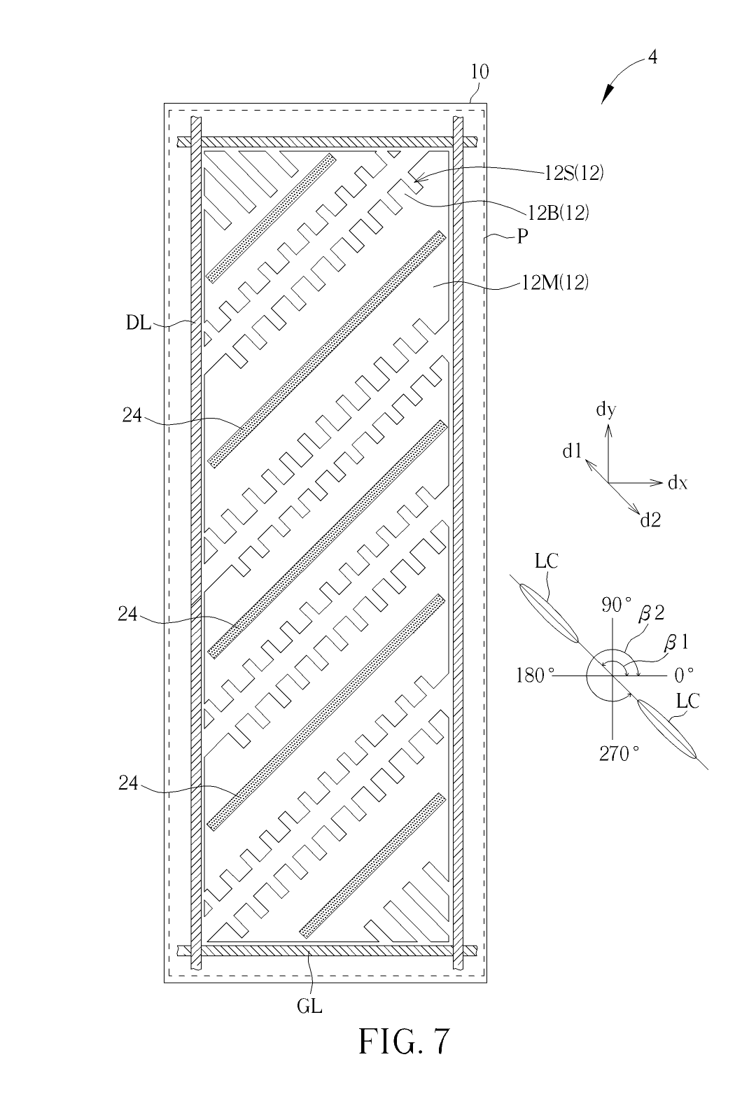

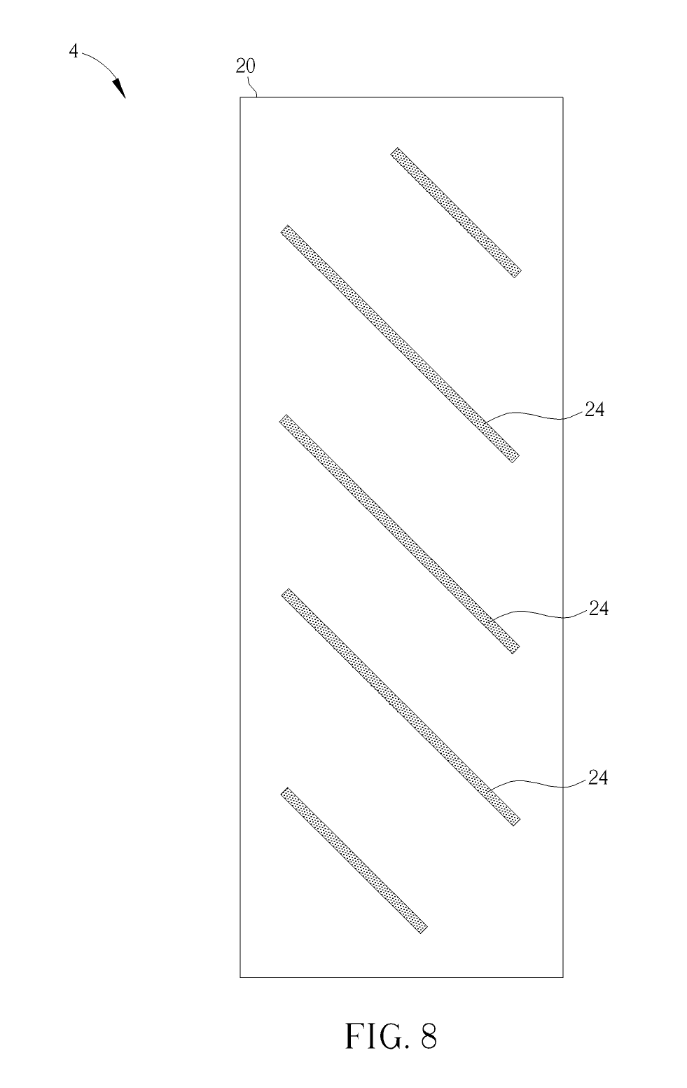

Please refer to FIG. 7 and FIG. 8, as well as FIG. 1. FIG. 7 schematically illustrates an array substrate of a pixel structure of a transparent LCD panel according to a third variant embodiment of the first embodiment, and FIG. 8 schematically illustrates a counter substrate of a pixel structure of a transparent LCD panel according to a third variant embodiment of the first embodiment. As shown in FIG. 7, in the pixel structure 4 of the transparent LCD panel of the third variant embodiment, the main electrodes 12M are disposed in parallel, and the branch electrodes 12B are connected to both sides of the main electrodes 12M. The branch electrodes 12B disposed between two adjacent main electrodes 12M are symmetrically arranged, i.e. one branch electrode 12B is corresponding to one corresponding branch electrode 12B, and one slit 12S is corresponding to one corresponding slit 12S. The branch electrodes 12B substantially have the same length, and the length of the branch electrode 12B is shorter than the width of the main electrode 12M. Additionally, the branch electrodes 12B disposed at two of the corner regions of the pixel P have unequal length design. In the pixel structure 4 of the transparent LCD panel of the third variant embodiment, the protrusion structures 24 are disposed on at least one of the array substrate 10 and the counter substrate 20. For example, the protrusion structures 24 may be disposed on the array substrate 10 as shown on FIG. 7, disposed on the counter substrate 20 as shown in FIG. 8, or disposed on both the array substrate 10 and the counter substrate 20.

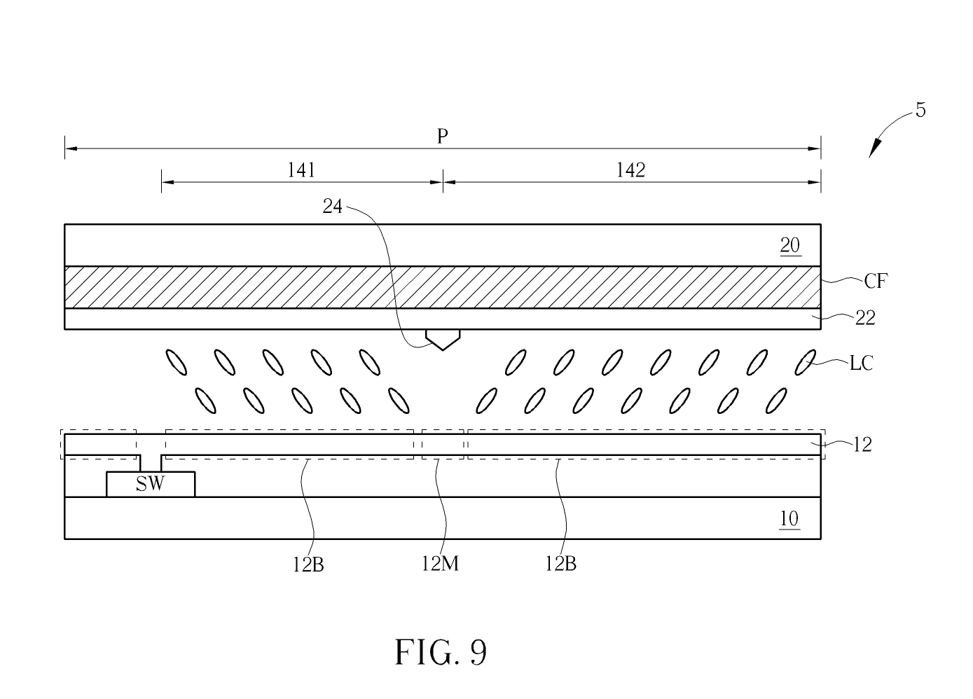

Please refer to FIG. 9. FIG. 9 is a schematic diagram illustrating a pixel structure of a transparent liquid crystal display panel according to another variant embodiment of a first embodiment of the present invention. As shown in FIG. 9, in this variant embodiment, the pixel structure 5 of the transparent LCD panel may further include a color filter pattern CF disposed on a surface of the counter substrate 20 facing the array substrate 10. That is to say, the pixel P may include a color sub-pixel, and thus the pixel structure 5 of the transparent LCD panel may include a plurality of pixels P configured to provide different colors. For example, the pixel structure 5 of the transparent LCD panel may include pixels for displaying three different colors e.g. red pixels, green pixels and blue pixels, or include pixels for displaying four different colors e.g. red pixels, green pixels, blue pixels and yellow pixels; or include pixels for displaying three different colors e.g. red pixels, green pixels and blue pixels, and a white pixel (as shown in FIG. 1). In addition, the arrangement of the main electrode 12M, the branch electrode 12B and the slit 12S of the pixel electrode 12 may be selected from the embodiments of FIGS. 2, 3, 5 and 7. Furthermore, alight-shielding pattern (not shown) may be disposed between adjacent pixels P, and the light-shielding pattern may be disposed on the counter substrate 20 or the array substrate 10.

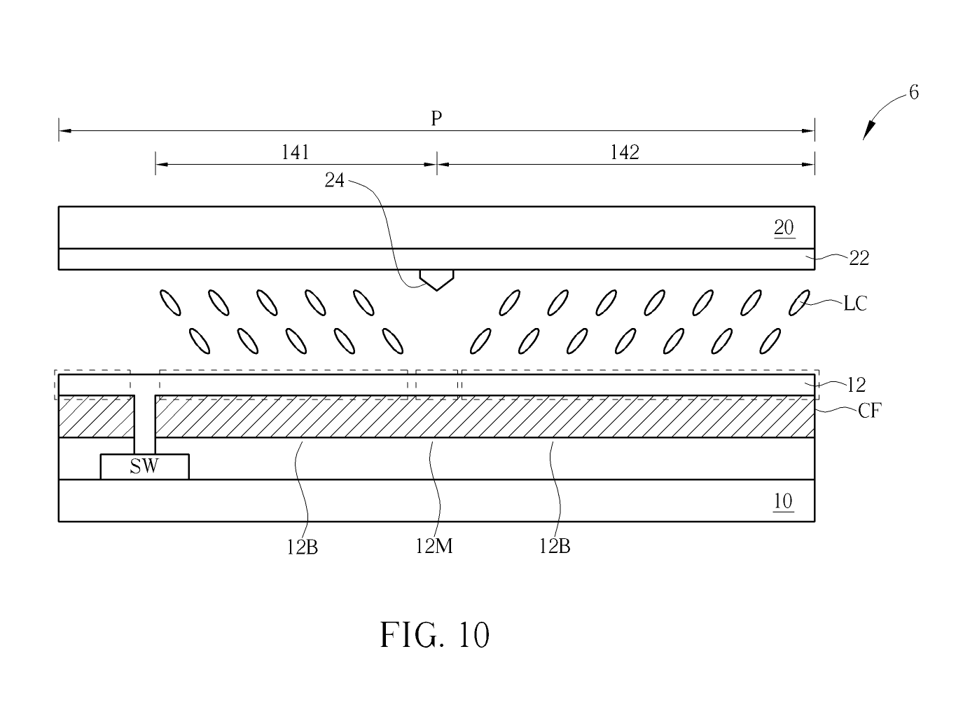

Please refer to FIG. 10. FIG. 10 is a schematic diagram illustrating a pixel structure of a transparent liquid crystal display panel according to still another variant embodiment of a first embodiment of the present invention. As shown in FIG. 10, in this variant embodiment, the pixel structure 6 of the transparent LCD panel may further include a color filter pattern CF disposed on a surface of the array substrate 10 facing the counter substrate 20. That is to say, the pixel P may include a color sub-pixel, and thus the pixel structure 6 of the transparent LCD panel may include a plurality of pixels P configured to provide different colors. For example, the pixel structure 6 of the transparent LCD panel may include pixels for displaying three different colors e.g. red pixels, green pixels and blue pixels, or include pixels for displaying four different colors e.g. red pixels, green pixels, blue pixels and yellow pixels; or include pixels for displaying three different colors e.g. red pixels, green pixels and blue pixels, and a white pixel (as shown in FIG. 1). In addition, the arrangement of the main electrode 12M, the branch electrode 12B and the slit 12S of the pixel electrode 12 may be selected from the embodiments of FIGS. 2, 3, 5 and 7. Furthermore, alight-shielding pattern (not shown) may be disposed between adjacent pixels P, and the light-shielding pattern may be disposed on the counter substrate 20 or the array substrate 10.

In each variant embodiment of the first embodiment, the pixel includes only two alignment regions, i.e. the liquid crystal molecules are aligned only along the first aligning direction and the second aligning direction. Consequently, no background image blur problem due to too many alignment regions will occur. Thus, the viewer can see clear and distinct images from the front side of the pixel structure of the transparent LCD panel of this embodiment, and display quality in a transparent display mode is improved.

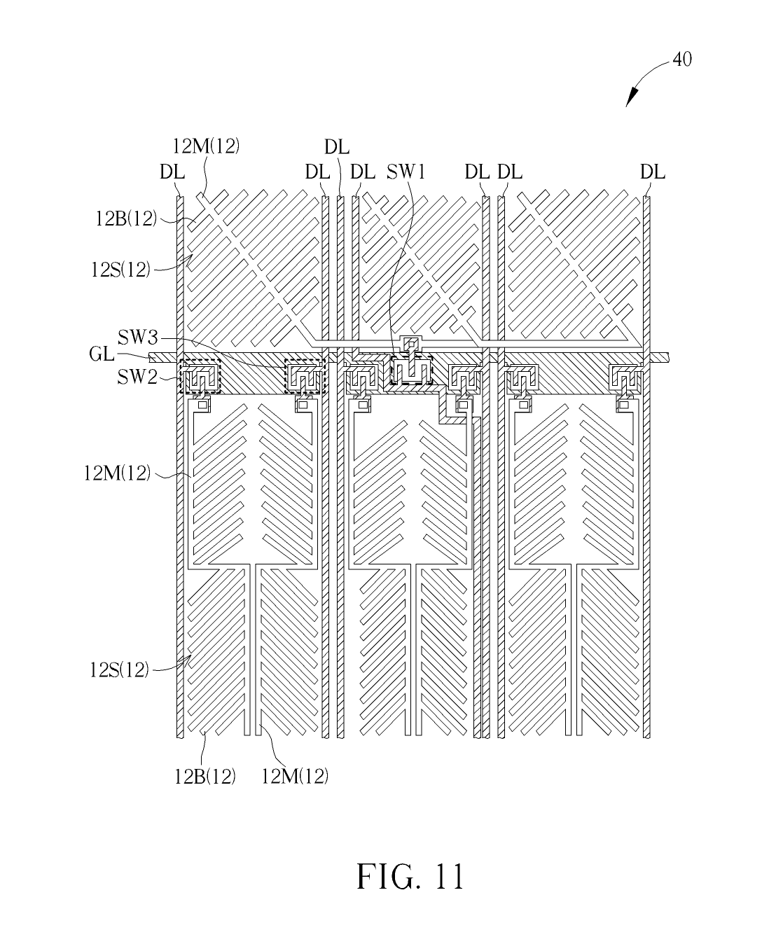

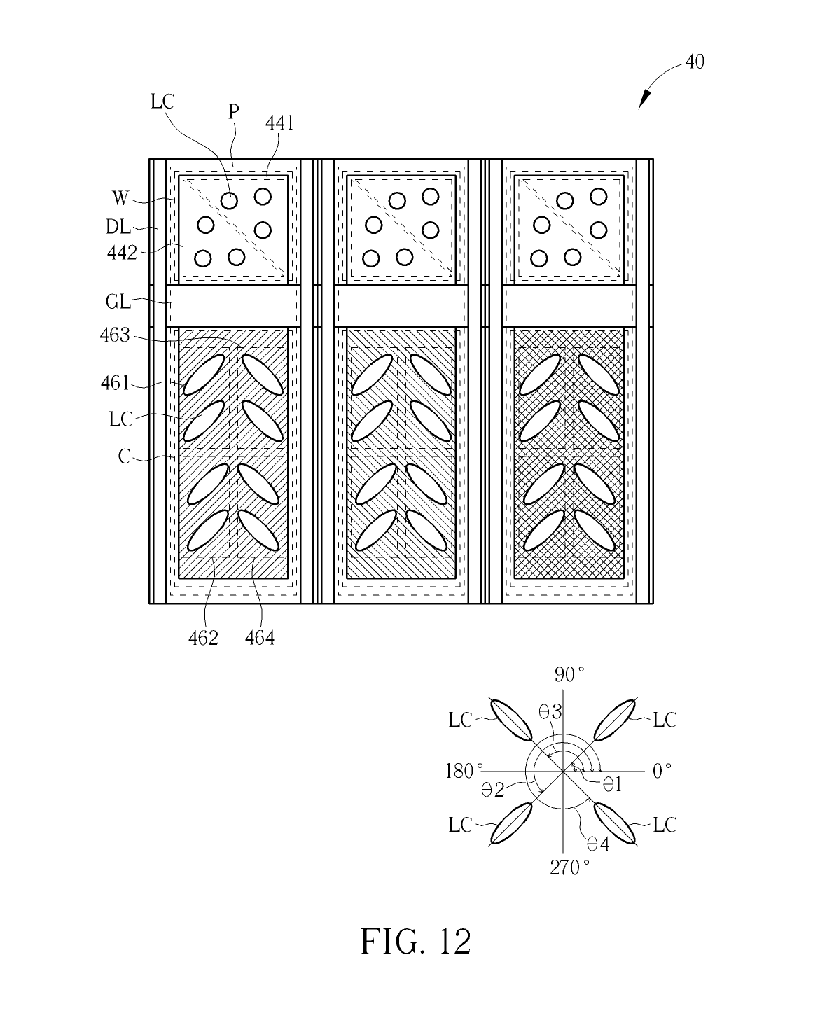

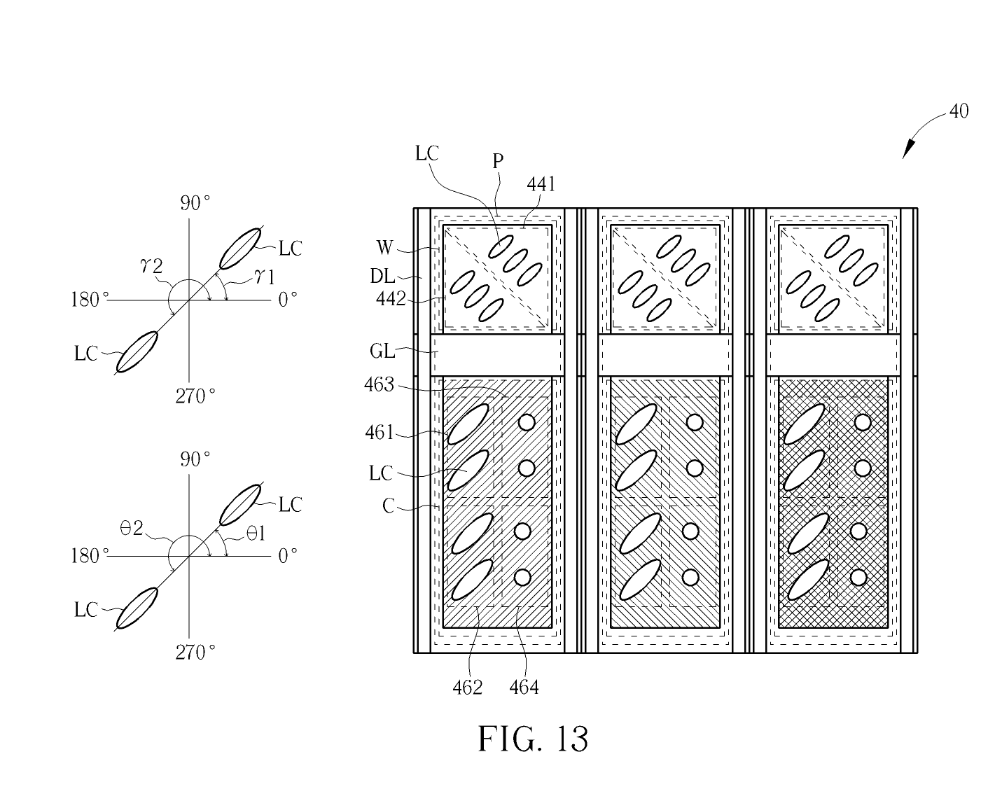

Please refer to FIGS. 11-13. FIG. 11 is a schematic diagram illustrating a pixel electrode of a pixel structure of a transparent LCD panel of a second embodiment of the present invention, FIG. 12 is a schematic diagram illustrating a pixel structure of a transparent LCD panel of a second embodiment of the present invention in an image display mode, and FIG. 13 is a schematic diagram illustrating a pixel structure of a transparent LCD panel of a second embodiment of the present invention in a transparent display mode. As shown in FIGS. 11-13, the pixel structure 40 of the transparent LCD panel of the second embodiment includes an array substrate 42, a plurality of gate lines GL, a plurality of data lines DL, a first active switching device SW1, a second active switching device SW2, a third active switching device SW3, a plurality of pixels P and liquid crystal molecules LC (not shown in FIG. 11). The liquid crystal molecules LC are disposed in the pixels P, and the liquid crystal molecules LC include vertically-aligned mode (VA mode) liquid crystal molecules, but not limited thereto. The pixel P includes a white sub-pixel W and a color sub-pixel C. The white sub-pixel W consists of a first alignment region 441 and a second alignment region 442 having different aligning directions. A pixel electrode 12 is disposed in the white sub-pixel W, and the pixel electrode 12 includes a main electrode 12 M disposed between the first alignment region 441 and the second alignment region 442, and a plurality of branch electrodes 12B connected to both sides of the main electrode 12M and extending to the first alignment region 441 and the second alignment region 442, respectively. The color sub-pixel C may be for example a red sub-pixel, a green sub-pixel, a blue sub-pixel or a sub-pixel of any other color. The color sub-pixel C includes more than two alignment regions e.g. a first alignment region 461, a second alignment region 462, a third alignment region 463 and a fourth alignment region 464. A pixel electrode 12 is disposed in the color sub-pixel C, and the pixel electrode 12 includes two main electrodes 12M, and a plurality of branch electrodes 12B connected to both sides of the main electrodes 12B and extending to the first alignment region 461, the second alignment region 462, the third alignment region 463 and the fourth alignment region 464, respectively. The number of alignment regions of the color sub-pixel C is not limited to four, and may be for example three, five or more. The first alignment region 461, the second alignment region 462, the third alignment region 463 and the fourth alignment region 464 of the color sub-pixel C have different aligning directions. The first alignment region 461 of the color sub-pixel C and the first alignment region 441 of the white sub-pixel W have substantially the same aligning direction, the second alignment region 462 of the color sub-pixel C and the second alignment region 442 of the white sub-pixel W have substantially the same aligning direction, and the third alignment region 463 and the fourth alignment region 464 of the color sub-pixel C and the first alignment region 441 and the second alignment region 442 of the white sub-pixel W have different aligning directions. The pixel structure 40 of the transparent LCD panel of this embodiment may further include other necessary devices (not shown) for implementing its display function such as alignment film, polarizer, color filter, light-shielding layer, storage capacitor line, etc, and the function and arrangement of the aforementioned devices are known and not redundantly described.

As shown in FIG. 12, in the image display mode, the first alignment region 441 and the second alignment region 442 of the white sub-pixel W have non-transparent display grayscale e.g. zero grayscale. For example, when the transparent LCD panel is a normally black (NB) display panel, and the upper and lower polarizers are orthogonally arranged, the liquid crystal molecules LC are not driven by electric voltage and thus are standing. Accordingly, non-transparent display effect can be implemented because light cannot penetrate through the first alignment region 441 and the second alignment region 442. Meanwhile, the first alignment region 461, the second alignment region 462, the third alignment region 463 and the fourth alignment region 464 of the color sub-pixel C have an image display grayscale, respectively, based on an image to be displayed. In other words, in the image display mode, all of the alignment regions of the color sub-pixel C may be turned, and have predetermined image display grayscales respectively based on the image to be displayed. Thus, in the image display mode, the liquid crystal molecules LC of the pixel structure 40 of the transparent LCD panel are multi-domain aligned (e.g. four domain aligned), and images of wide viewing angle can be provided. In the image display mode, a difference between the azimuth angle θ1 of the long axis of the liquid crystal molecules LC disposed in the first alignment region 461 of the color sub-pixel C and an azimuth angle θ3 of a long axis of the liquid crystal molecules LC disposed in the third alignment region 463 of the color sub-pixel C is substantially 90 degrees, a difference between the azimuth angle θ3 of the long axis of the liquid crystal molecules LC disposed in the third alignment region 463 of the color sub-pixel C and the azimuth angle θ2 of the long axis of the liquid crystal molecules LC disposed in the second alignment region 462 of the color sub-pixel C is substantially 90 degrees, a difference between the azimuth angle θ2 of the long axis of the liquid crystal molecules LC disposed in the second alignment region 462 of the color sub-pixel and an azimuth angle θ4 of a long axis of the liquid crystal molecules LC disposed in the fourth alignment region 464 of the color sub-pixel C is substantially 90 degrees, and a difference between the azimuth angle θ4 of the long axis of the liquid crystal molecules LC disposed in the fourth alignment region 464 of the color sub-pixel C and the azimuth angle θ1 of the long axis of the liquid crystal molecules LC disposed in the first alignment region 461 of the color sub-pixel C is substantially 90 degrees. For example, the azimuth angle θ1 is substantially 45 degrees, the azimuth angle θ2 is substantially 225 degrees, the azimuth angle θ3 is substantially 135 degrees, and the azimuth angle θ4 is substantially 315 degrees, but not limited thereto.

As shown in FIG. 13, in the transparent display mode, the first alignment region 441 and the second alignment region 442 of the white sub-pixel Wand the first alignment region 461 and the second alignment region 462 of the color sub-pixel C have a transparent display grayscale e.g. a maximum grayscale, and the third alignment region 463 and the fourth alignment region 464 of the color sub-pixel C have a non-transparent display grayscale e.g. a zero grayscale. In other words, in the transparent display mode, the first alignment region 441 and the second alignment region 442 of the white sub-pixel W are both turned, and the first alignment region 461 and the second alignment region 462 of the color sub-pixel C, which have the same aligning direction as the first alignment region 441 and the second alignment region 442 of the white sub-pixel W, are also both turned on, while the third alignment region 463 and the fourth alignment region 464 of the color sub-pixel C, which have different aligning directions from the first alignment region 441 and the second alignment region 442 of the white sub-pixel W, are turned off. In the transparent display mode, a difference between an azimuth angle γ1 of a long axis of the liquid crystal molecules LC disposed in the first alignment region 441 of the white sub-pixel W and an azimuth angle γ2 of a long axis of the liquid crystal molecules LC disposed in the second alignment region 442 of the white sub-pixel W is substantially 180 degrees, and a difference between an azimuth angle θ1 of a long axis of the liquid crystal molecules LC disposed in the first alignment region 461 of the color sub-pixel C and an azimuth angle θ2 of a long axis of the liquid crystal molecules LC disposed in the second alignment region 462 of the color sub-pixel C is substantially 180 degrees. In addition, the azimuth angle γ1 and the azimuth angle θ1 are substantially the same, and the azimuth angle γ2 and the azimuth angle θ2 are substantially the same. For example, the azimuth angle γ1 and the azimuth angle θ1 are both substantially 45 degrees, and the azimuth angle γ2 and the azimuth angle θ2 are both substantially 225 degrees, but not limited thereto.

As shown in FIG. 11, in order to independently control the first alignment region 441 and the second alignment region 442 of the white sub-pixel W and the first alignment region 461, the second alignment region 462, the third alignment region 463 and the fourth alignment region 464 of the color sub-pixel C, the first alignment region 441 and the second alignment region 442 of the white sub-pixel W may be controlled by the first active switching device SW1, the first alignment region 461 and the second alignment region 462 of the color sub-pixel C can be controlled by the second active switching device SW2, and the third alignment region 463 and the fourth alignment region 464 of the color sub-pixel C can be controlled by the third active switching device SW3. In a variant embodiment, the first alignment region 441 and the second alignment region 442 of the white sub-pixel W and the first alignment region 461, the second alignment region 462, the third alignment region 463 and the fourth alignment region 464 of the color sub-pixel C can be controlled by a plurality of active switching devices, respectively.

By virtue of the aforementioned arrangement and driving method, in the transparent display mode, the liquid crystal molecules only have two aligning directions, which can avoid the background image blur problem caused by too many aligning directions. Thus, the viewer can see clear and distinct images from the front side of the pixel structure of the transparent LCD panel of this embodiment, and display quality in a transparent display mode is improved. In another aspect, in the image display mode, the liquid crystal molecules are multi-domain aligned, which can provide an image of wide viewing angle. The pixel structure 40 of the transparent LCD panel of this embodiment can selectively provide only the transparent display mode, only the image display mode, or locally provide the transparent display mode and locally provide the image display mode at the same time.

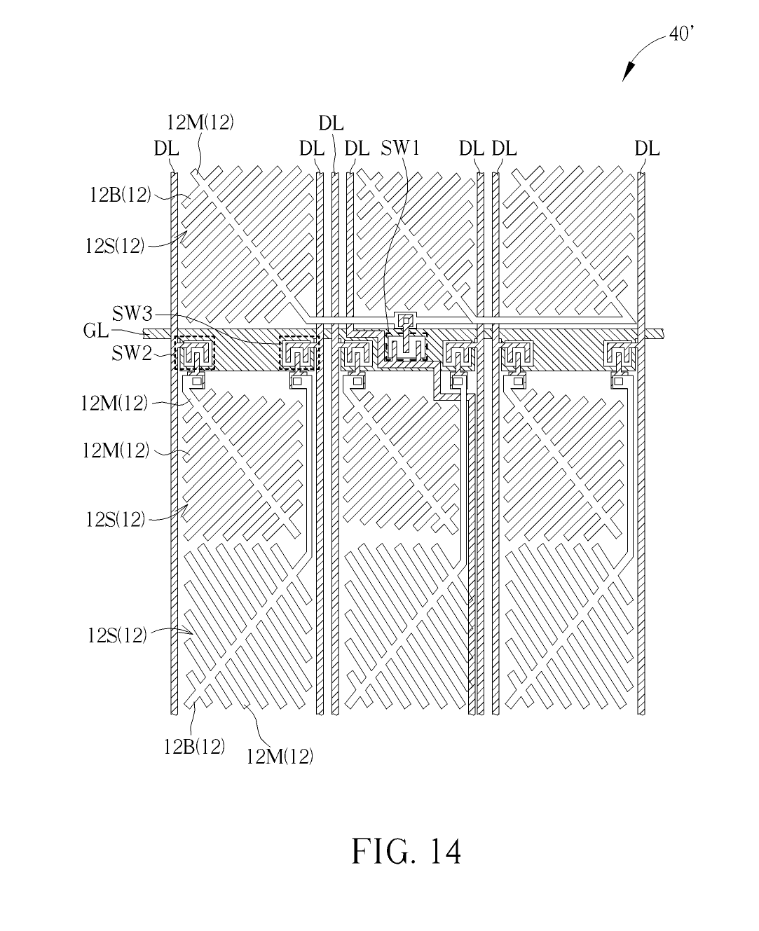

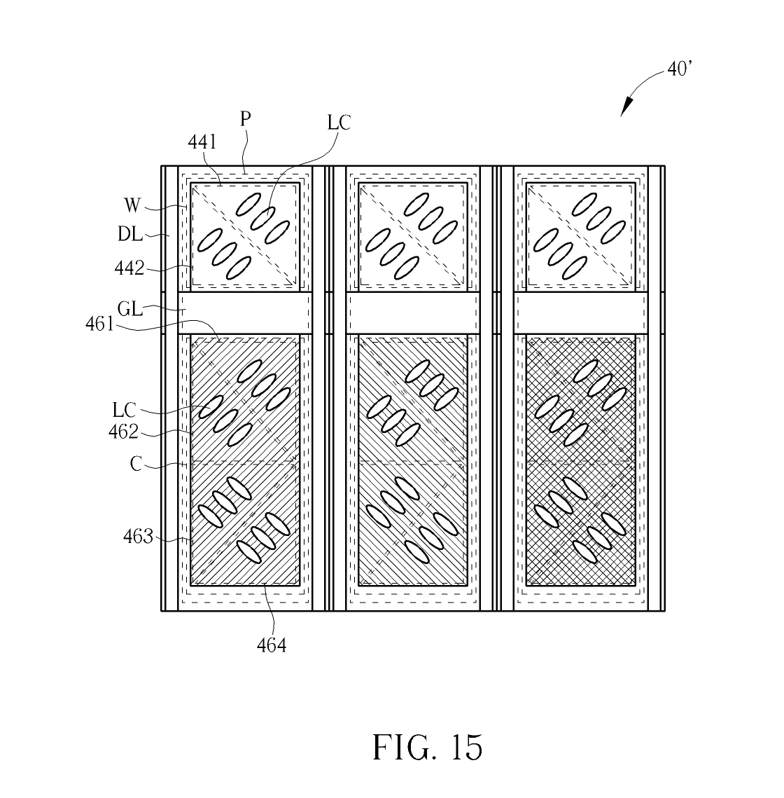

Please refer to FIG. 14 and FIG. 15. FIG. 14 is a schematic diagram illustrating a pixel electrode of a pixel structure of a transparent LCD panel of a variant embodiment of a second embodiment of the present invention, and FIG. 15 is a schematic diagram illustrating a pixel structure of a transparent LCD panel of a variant embodiment of a second embodiment of the present invention. As shown in FIG. 14 and FIG. 15, in the pixel structure 40′ of the transparent LCD panel of the variant embodiment, the pixel P includes a white sub-pixel W and a color sub-pixel C. The white sub-pixel W consists of a first alignment region 441 and a second alignment region 442 having different aligning directions. A pixel electrode 12 is disposed in the white sub-pixel W, and the pixel electrode 12 includes a main electrode 12 M disposed between the first alignment region 441 and the second alignment region 442, and a plurality of branch electrodes 12B connected to both sides of the main electrode 12M and extending to the first alignment region 441 and the second alignment region 442, respectively. The color sub-pixel C includes a first alignment region 461, a second alignment region 462, a third alignment region 463 and a fourth alignment region 464. A pixel electrode 12 is disposed in the color sub-pixel C, and the pixel electrode 12 includes two main electrodes 12M, and a plurality of branch electrodes 12B connected to both sides of the main electrodes 12B and extending to the first alignment region 461, the second alignment region 462, the third alignment region 463 and the fourth alignment region 464, respectively. The arrangement of alignment regions of the pixel structure 40′ of the transparent LCD panel of the variant embodiment is different from that in the second embodiment, but the pixel structure 40′ of the transparent LCD panel of the variant embodiment can be driven by the same driving method to have only two alignment regions in the transparent display mode for avoiding background blur problem and to have multiple alignment domains in the image display mode for providing wide view angle effect. The number of alignment regions of the color sub-pixel C is not limited to four, and may be for example three, five or more.

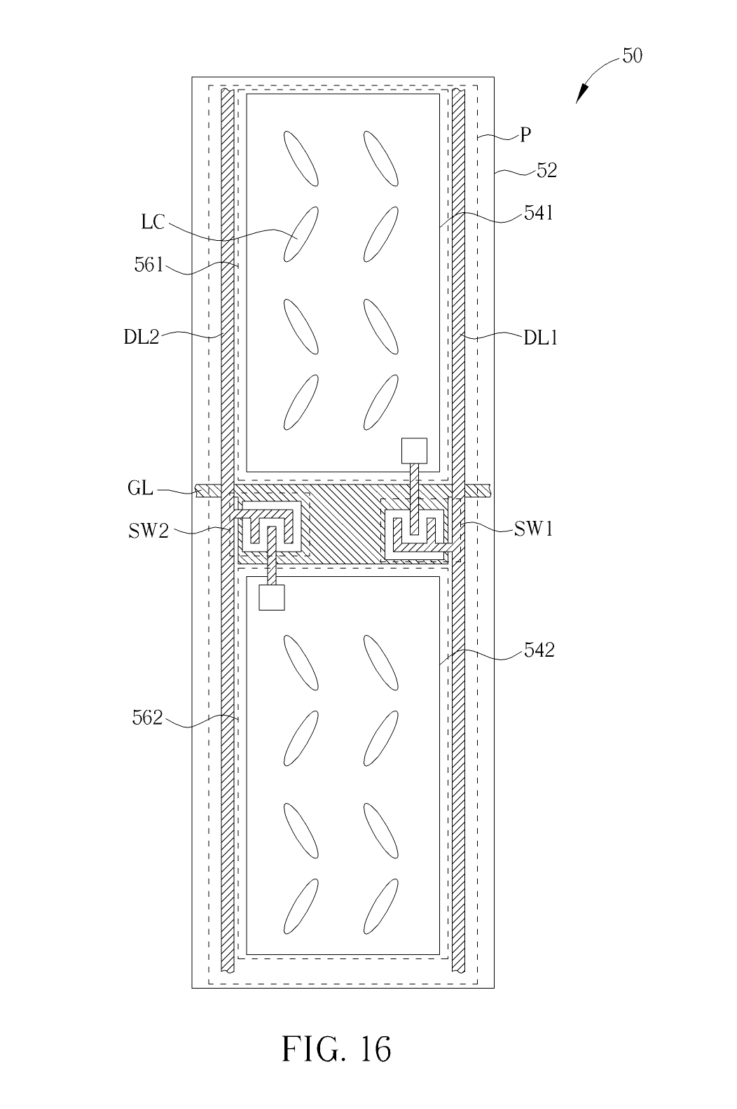

Please refer to FIG. 16. FIG. 16 is a schematic diagram of a pixel structure of a transparent LCD panel according to a third embodiment of the present invention. As shown in FIG. 16, the pixel structure 50 of the transparent LCD panel of this embodiment includes an array substrate 52, a pixel P, liquid crystal molecules LC, a first active switching device SW1, a first pixel electrode 541, a second active switching device SW2 and a second pixel electrode 542. The liquid crystal molecules LC are disposed in the pixel P, and the liquid crystal molecules LC include anti-ferroelectric liquid crystal molecules, but not limited thereto. The pixel P includes a first alignment region 561 and a second alignment region 562. The first active switching device SW1 is disposed on the array substrate 52, and the first pixel electrode 541 is disposed on the array substrate 52 in the first alignment region 561 and electrically connected to the first active switching device SW1. The second active switching device SW2 is disposed on the array substrate 52, and the second pixel electrode 542 is disposed on the array substrate 52 in the second alignment region 562 and electrically connected to the second active switching device SW2. The first active switching device SW1 and the second active switching device SW2 share the same gate line GL, and receive data signals from a first data line DL1 and a second data line DL2, respectively. The liquid crystal molecules LC, when not being driven, are aligned along two different aligning directions in the first alignment region 561 and the second alignment region 562. The pixel structure 50 of the transparent LCD panel of this embodiment may further include other necessary devices (not shown) for implementing display function such as alignment film, polarizer, color filter, light-shielding layer, storage capacitor line, etc, and the function and arrangement of the aforementioned devices are known and not redundantly described.

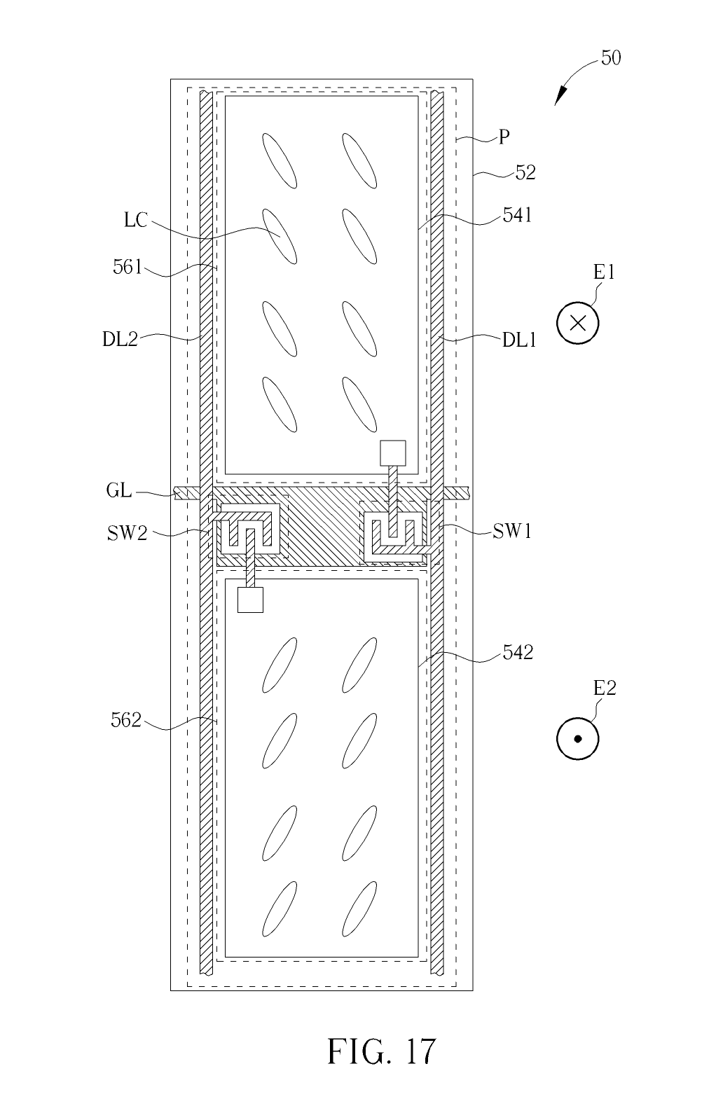

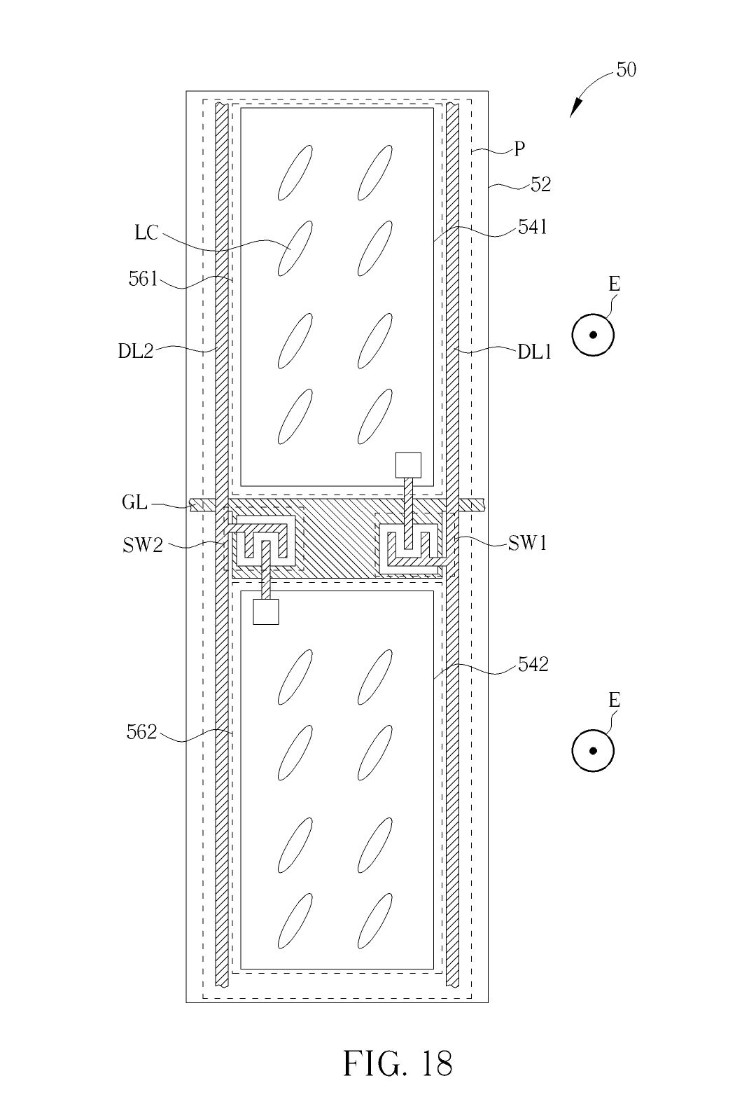

Please refer to FIG. 17 and FIG. 18. FIG. 17 is a schematic diagram illustrating a pixel structure of a transparent LCD panel of a third embodiment of the present invention in an image display mode, and FIG. 18 is a schematic diagram illustrating a pixel structure of a transparent LCD panel of a third embodiment of the present invention in a transparent display mode. As shown in FIG. 17, in the image display mode, the liquid crystal molecules LC disposed in the first alignment region 561 has only one aligning direction, the liquid crystal molecules LC disposed in the second alignment region 562 has only one aligning direction, and the aligning directions of the liquid crystal molecules LC disposed in the first alignment region 561 and the second alignment region 562 are different. In this embodiment, the liquid crystal molecules LC disposed in the first alignment region 561 and the second alignment region 562 are driven by two vertical electric fields of opposite directions. For example, the data signals delivered by the first data line DL1 and the second data line DL2 have opposite polarities. In such case, the liquid crystal molecules LC disposed in the first alignment region 561 is driven by a vertical electric field E1, while the liquid crystal molecules LC disposed in the second alignment region 562 is driven by a vertical electric field E2, where the vertical electric field E1 and the vertical electric field E2 have opposite directions. In addition, in the image display mode, the first alignment region 561 and the second alignment region 562 are driven by a field sequential color (FSC) driving method. Specifically, a backlight module (not shown) able to emit lights of different colors e.g. red light, green light and blue light is used to provide backlight for the pixel structure 50 of the transparent LCD panel. Accordingly, the first alignment region 561 and the second alignment region 562 can display colorful image in the image display mode, and the grayscale can be adjusted by controlling the turn-on time of the first alignment region 561 and the second alignment region 562.

As shown in FIG. 18, in the transparent display mode, the liquid crystal molecules LC disposed in the first alignment region 561 and the second alignment region 562 substantially have the same aligning direction. In this embodiment, the liquid crystal molecules LC disposed in the first alignment region 561 and the second alignment region 562 are driven by a vertical electric filed of the same direction, and thus are aligned along the same aligning direction. For example, the data signals delivered by the first data line DL1 and the second data line DL2 have the same polarity, and thus the liquid crystal molecules LC disposed in the first alignment region 561 and the second alignment region 562 are driven by the same vertical electric filed E.

The pixel structure 50 of the transparent LCD panel of this embodiment can selectively provide only the transparent display mode, only the image display mode, or locally provide the transparent display mode and locally provide the image display mode at the same time.

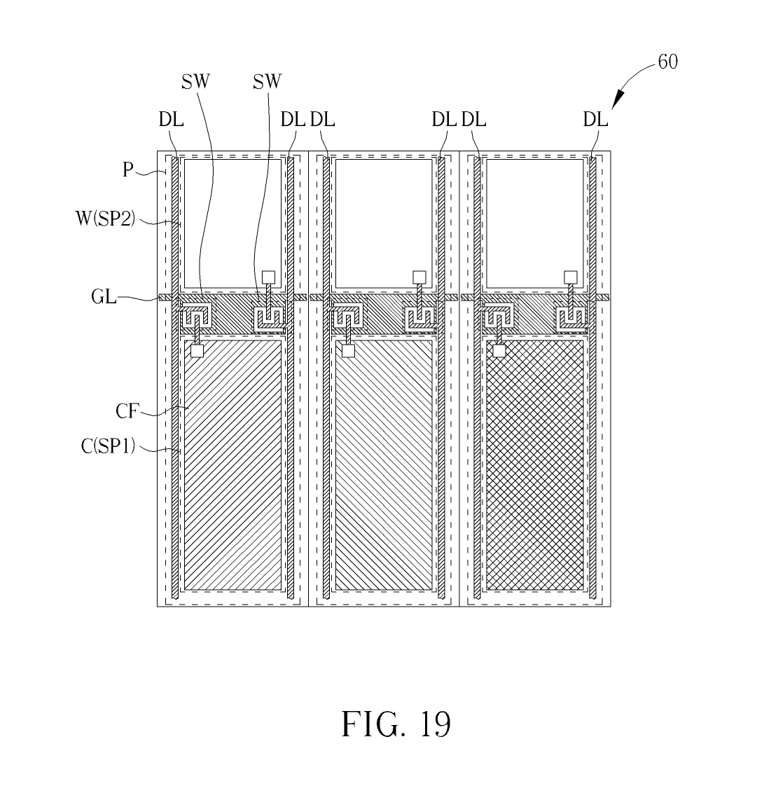

Please refer to FIG. 19. FIG. 19 is a schematic diagram illustrating a pixel structure of a transparent LCD panel of a fourth embodiment of the present invention. As shown in FIG. 19, the pixel structure 60 of the transparent LCD panel of this embodiment includes a gate line GL, a plurality of data lines DL, a plurality of pixels P and a plurality of active switching devices SW. Each pixel P includes a first sub-pixel SP1 for providing a first display image, and a second sub-pixel SP2 for displaying a second display image. The active switching devices SW share the same gate line GL, and receive data signals from different data lines DL, respectively, to control the first sub-pixel SP1 and the second sub-pixel SP2. In this embodiment, the first sub-pixel SP1 is a color sub-pixel C, and the second sub-pixel SP2 is a white sub-pixel W, where the color sub-pixel C includes a color filter pattern CF, and the white sub-pixel W does not include a color filter pattern. The first sub-pixel SP1 may be selected from any one of the sub-pixels of three different colors including a red sub-pixel, a green sub-pixel and a blue sub-pixel, or selected from any one of the sub-pixels of four different colors. The color filter pattern CF may be, for example, a red filter pattern, a green filter pattern, a blue filter pattern or other color filter pattern. The color space coverage of the first sub-pixel SP1, which includes the color filter pattern CF, is higher than the color space coverage of the second sub-pixel SP2, which does not include color filter pattern. In the text, the color space coverage may be, for example, National Television System Committee (NTSC) color space coverage (also referred to as NTSC coverage), sRGB color space coverage (also referred to sRGB coverage) or a color space coverage defined by another standard. In the image display mode, the first sub-pixel SP1 of each pixel P has an image display grayscale based on an image to be displayed, and the second sub-pixel SP2 of each pixel P has a non-transparent display grayscale e.g. a zero grayscale, i.e. the second sub-pixel SP2 is turned off. Accordingly, the pixel structure 60 of the transparent LCD panel of this embodiment can provide images with high color saturation in the image display mode. In the transparent display mode, the first sub-pixel SP1 and the second sub-pixel SP2 of each pixel P have a transparent display grayscale e.g. a maximum grayscale, i.e. the first sub-pixel SP1 and the second sub-pixel SP2 of each pixel P are turned on. Accordingly, the pixel structure 60 of the transparent LCD panel of this embodiment has excellent light transmittance in the transparent display mode.

The pixel structure 60 of the transparent LCD panel of this embodiment may further include other necessary devices (not shown) for implementing its display function such as alignment film, polarizer, color filter, light-shielding layer, storage capacitor line, etc, and the function and arrangement of the aforementioned devices are known and not redundantly described. The pixel structure 60 of the transparent LCD panel of this embodiment can selectively provide only the transparent display mode, only the image display mode, or locally provide the transparent display mode and locally provide the image display mode at the same time.

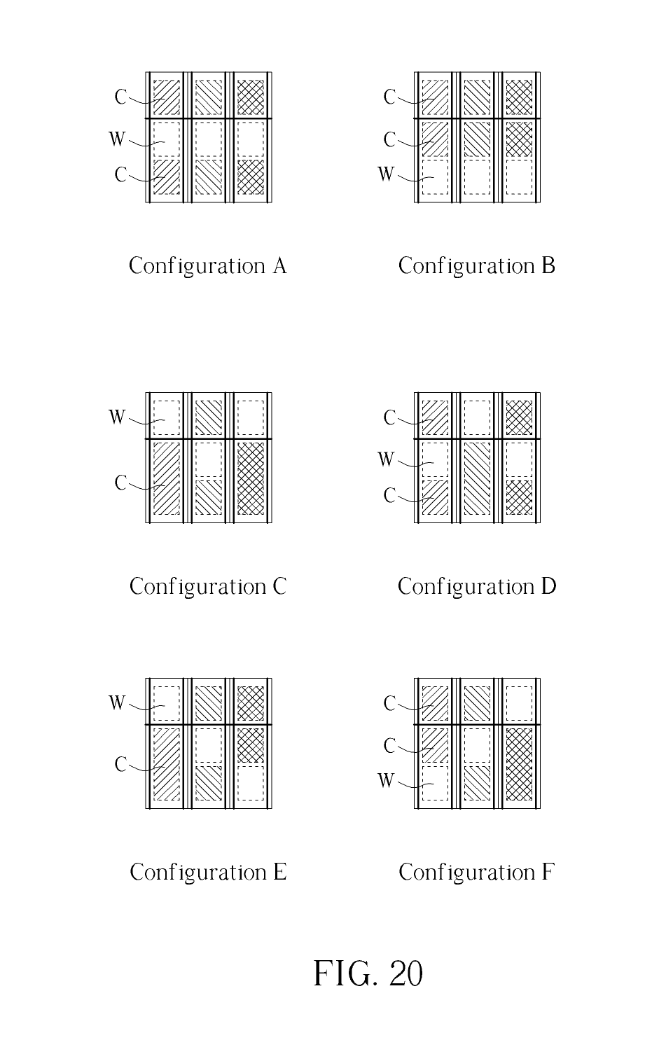

Please refer to FIG. 20. FIG. 20 depicts several different configurations of a pixel structure of a transparent LCD panel of this embodiment. As shown in FIG. 20, the white sub-pixel W and the color sub-pixel C may be arranged as any one of configurations A-F. For example, the while sub-pixel W may be disposed on any side of the color sub-pixel C, between the color sub-pixels C or surrounded by the color sub-pixel C. In addition, in different pixels P, the arrangement of the white sub-pixel W and the color sub-pixel C may be different. Also, in configurations A-F, the white sub-pixel W may be turned on and turned off by an active switching device.

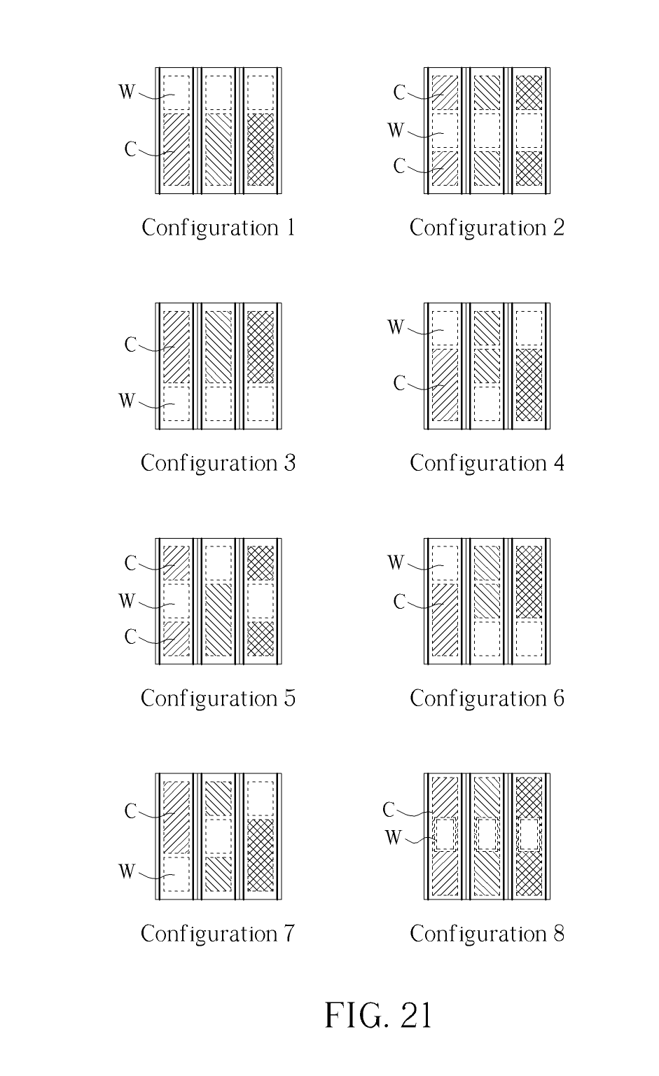

Please refer to FIG. 21. FIG. 21 depicts several other different configurations of a pixel structure of a transparent LCD panel of this embodiment. As shown in FIG. 21, the white sub-pixel W and the color sub-pixel C may be arranged as any one of configurations 1-8. For example, the while sub-pixel W may be disposed on any side of the color sub-pixel C, between the color sub-pixels C, or surrounded by the color sub-pixel C. Also, in different pixels P, the arrangement of the white sub-pixel W and the color sub-pixel C may be different. In addition, in configurations 1-8, the white sub-pixel W is an opening, which is not controlled by active switching device.

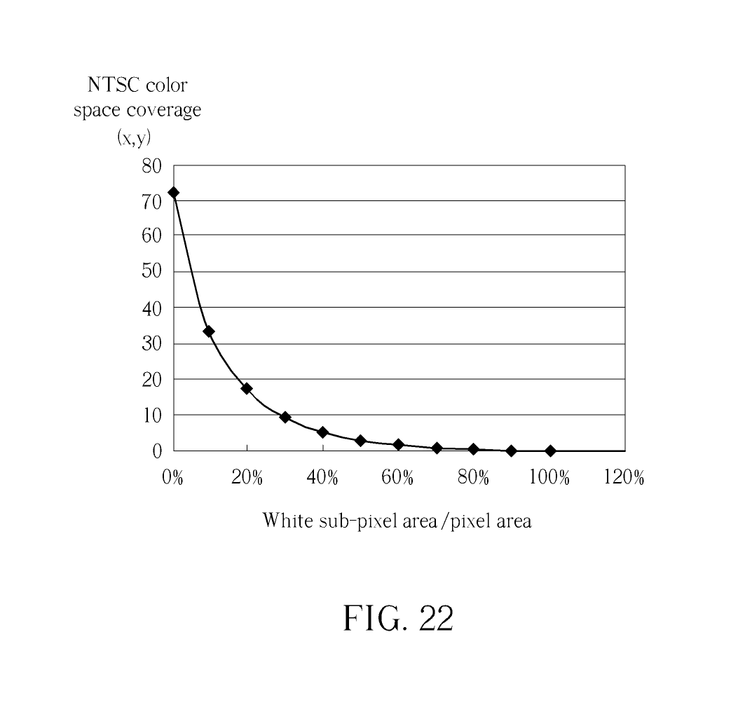

Please refer to FIG. 22. FIG. 22 illustrates a relation between NTSC color space coverage and an area ratio of white sub-pixel to pixel. As the area ratio of white sub-pixel W to pixel P increases, the NTSC color space coverage decreases. Therefore, the area ratio of white sub-pixel W to pixel P may be adjusted based on required NTSC color space coverage when designing the pixel layout. For example, in order to achieve better transparent display effect, the area ratio of white sub-pixel W to pixel P is preferably higher than 10%, and the NTSC color space coverage is substantially lower than 35% accordingly. Thus, high light transmittance can be obtained. In order to achieve better image display effect, the area ratio of white sub-pixel W to pixel P is preferably lower than 8%, and the NTSC color space coverage is substantially higher than 45% accordingly. Thus, high color saturation can be obtained.

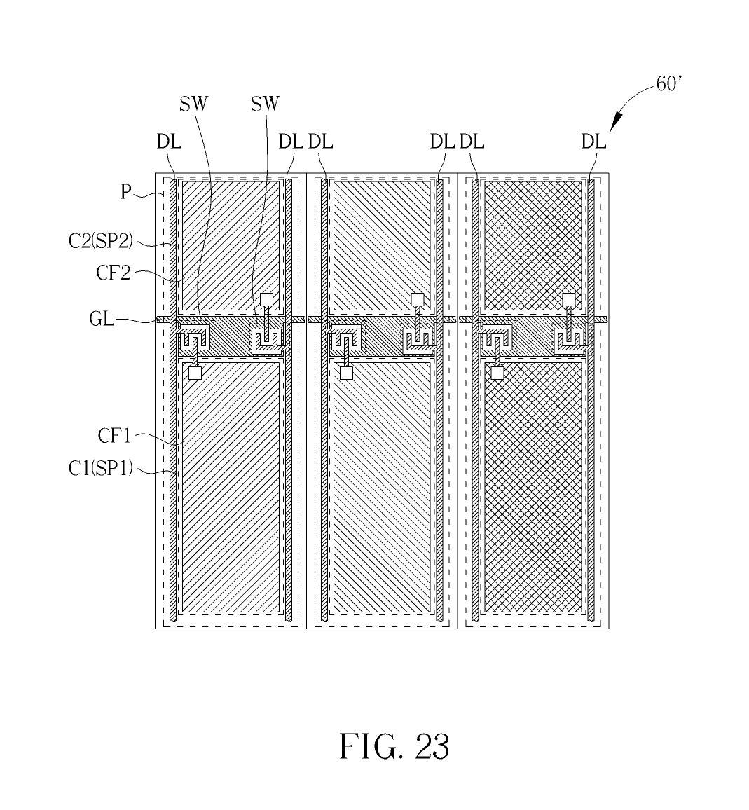

Please refer to FIG. 23. FIG. 23 is a schematic diagram illustrating a pixel structure of a transparent LCD panel of a variant embodiment of a fourth embodiment of the present invention. As shown in FIG. 23, in the pixel structure 60′ of the transparent LCD panel of this variant embodiment, the first sub-pixel SP1 is a first color sub-pixel C1, and the second sub-pixel SP2 is a second color sub-pixel C2. The first color sub-pixel C1 includes a first color filter pattern CF1, the second color sub-pixel C2 includes a second color filter pattern CF2, and the thickness of the first color filter pattern CF1 is larger than the thickness of the second color filter pattern CF2. Since the thickness of the first color filter pattern CF1 is larger than the thickness of the second color filter pattern CF2, the color space coverage of the first display image provided by the first sub-pixel SP1 is higher than the color space coverage of the second display image provided by the second sub-pixel SP2. The pixel structure 60′ of the transparent LCD panel of this variant embodiment can selectively provide the transparent display mode and/or the image display mode, and the driving method thereof is similar to that of the fourth embodiment.

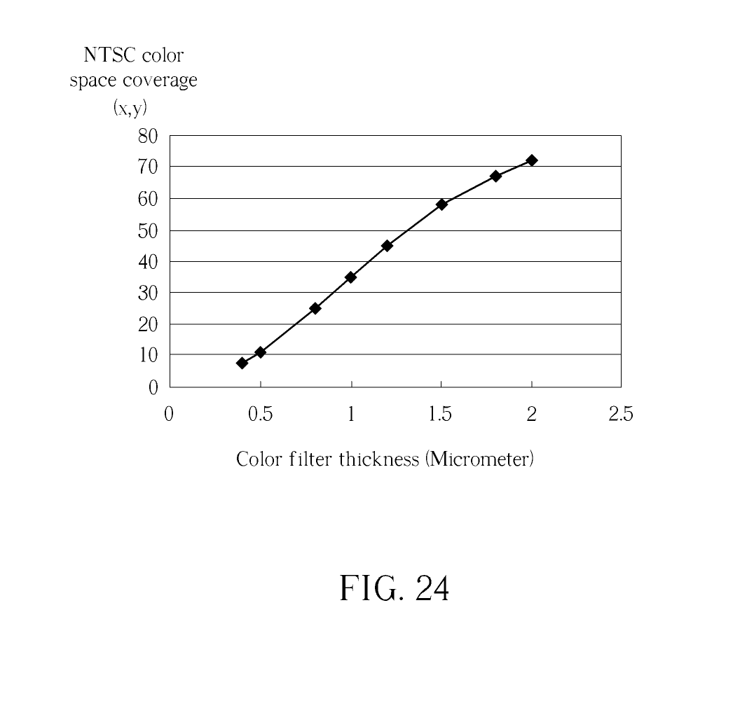

Please refer to FIG. 24. FIG. 24 illustrates a relation between NTSC color space coverage and thickness of color filter. As the thickness of color filter increases, the NTSC color space coverage increases accordingly. Therefore, the thickness of the color filter can be adjusted based on required NTSC color space coverage when designing the color filter. For example, in order to achieve better transparent display effect, the thickness of the color filter is preferably less than 1 micrometer, and the NTSC color space coverage is substantially lower than 35% accordingly. Thus, high light transmittance can be obtained. In order to achieve better image display effect, the thickness of the color filter is preferably greater than 1.2 micrometer, and the NTSC color space coverage is substantially higher than 45% accordingly. Thus, high color saturation can be obtained.

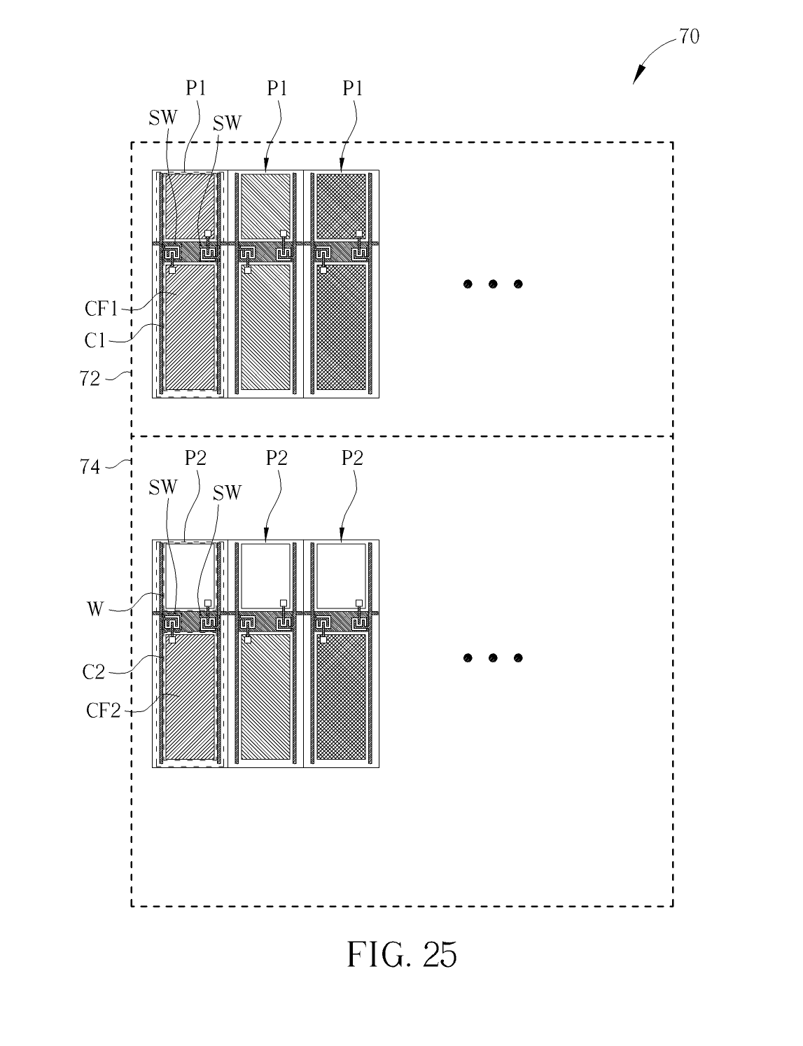

Please refer to FIG. 25. FIG. 25 is a schematic diagram illustrating a pixel structure of a transparent LCD panel of a fifth embodiment of the present invention. As shown in FIG. 25, the pixel structure 70 of the transparent LCD panel of this embodiment includes a first pixel P1 disposed in a display region 72 for providing a first display image, and a second pixel P2 disposed in a transparent region 74 for providing a second display image. The color space coverage of the first display image is higher than the color space coverage of the second display image. In this embodiment, the first pixel P1 includes a first color sub-pixel C1, and the second pixel P2 includes a second color sub-pixel C2 and a white sub-pixel W. The first color sub-pixel C1 includes a first color filter pattern CF1, the second color sub-pixel C2 includes a second color filter pattern CF2, and the white sub-pixel W does not include a color filter pattern. The thickness of the first color filter pattern CF1 and the thickness of the second color filter pattern CF2 may be equal or unequal. The first pixel P1 disposed in the display region 72 does not include a white sub-pixel, and thus the first display image has higher color saturation; the second pixel P2 disposed in the transparent region includes a white sub-pixel W, thereby having higher light transmittance. In this embodiment, the area of the white sub-pixel W of the second pixel P2 can be adjusted based on the required NTSC color space coverage, and the relation between the area of the white sub-pixel W and NTSC color space coverage is illustrated in FIG. 22 and its related texts. In this embodiment, the first color sub-pixel C1, the second color sub-pixel C2 and the white sub-pixel W can be controlled by active switching devices SW, respectively. The location of the white sub-pixel W is not limited, and may be modified as illustrated in FIG. 20 based on different visual consideration or other reasons.

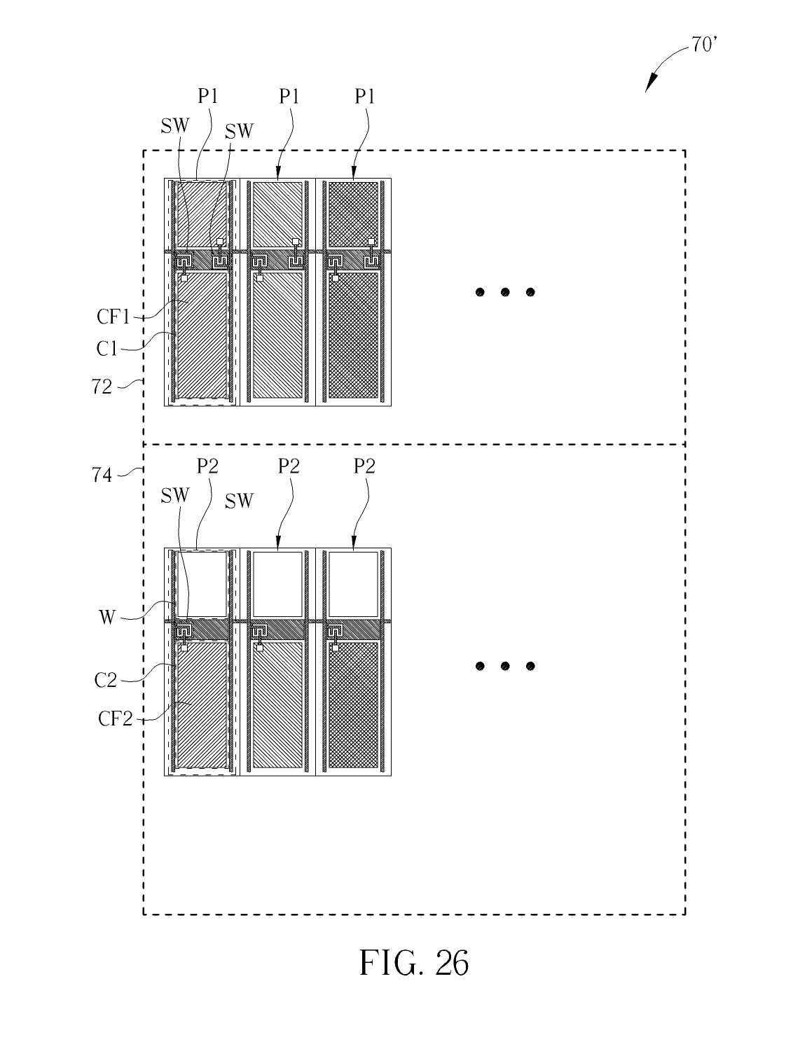

Please refer to FIG. 26. FIG. 26 is a schematic diagram illustrating a pixel structure of a transparent LCD panel of a first variant embodiment of a fifth embodiment of the present invention. As shown in FIG. 26, in the pixel structure 70′ of the transparent LCD panel of this variant embodiment, the white sub-pixel W is an opening, which is not controlled by an active switching device. The location of the white sub-pixel W is not limited, and may be modified as illustrated in FIG. 21 based on different visual consideration or other reasons.

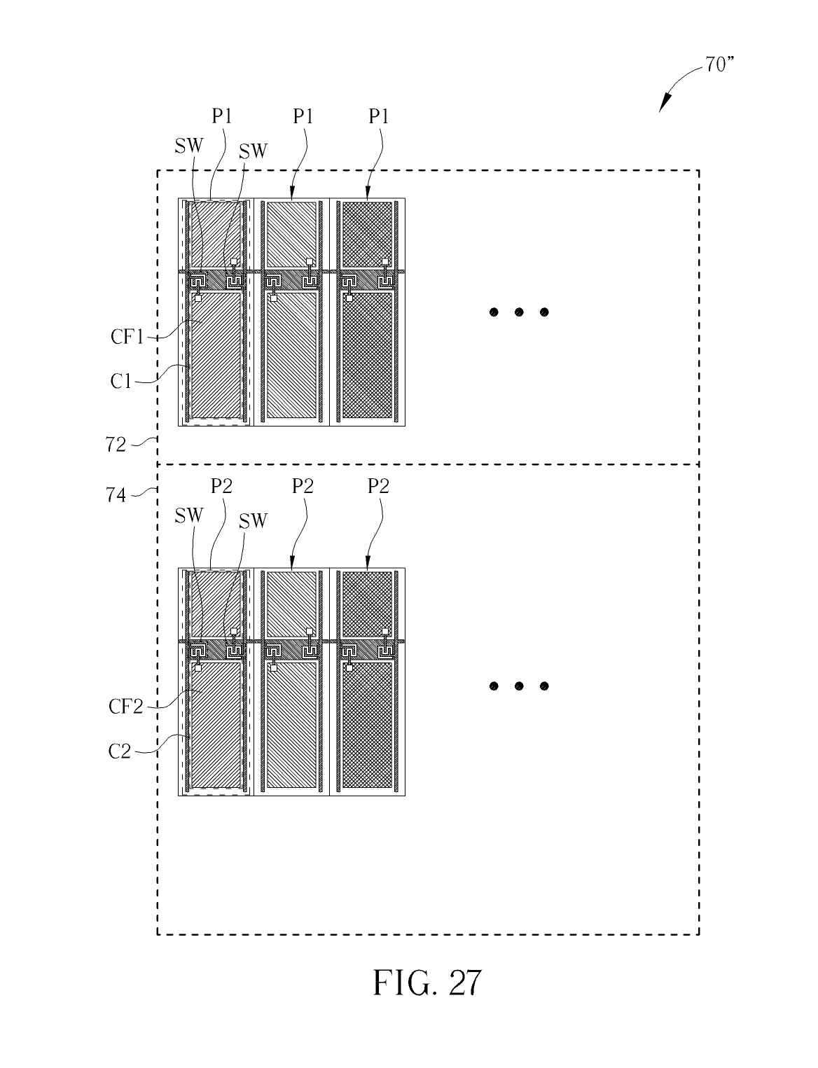

Please refer to FIG. 27. FIG. 27 is a schematic diagram illustrating a pixel structure of a transparent LCD panel of a second variant embodiment of a fifth embodiment of the present invention. As shown in FIG. 27, the pixel structure 70″ of the transparent LCD panel of this variant embodiment includes a first pixel P1 disposed in a display region 72 for providing a first display image, and a second pixel P2 disposed in a transparent region 74 for providing a second display image. The color space coverage of the first display image is higher than the color space coverage of the second display image. In this embodiment, the first pixel P1 includes a first color sub-pixel C1, and the second pixel P2 includes a second color sub-pixel C2. The first color sub-pixel C1 includes a first color filter pattern CF1, the second color sub-pixel C2 includes a second color filter pattern CF2, and the thickness of the first color filter pattern CF1 is greater than the thickness of the second color filter pattern CF2. Since the thickness of the first color filter pattern CF1 is greater than the thickness of the second color filter pattern CF2, the first display image has higher color saturation, while the second display image has higher light transmittance. In this embodiment, the thickness of the first color filter pattern CF1 and the thickness of the second color filter pattern CF2 can be adjusted based on the required NTSC color space coverage, and the relation between thickness of color filter and NTSC color space coverage is illustrated in FIG. 24 and its related texts.

In conclusion, the pixel structure of the transparent LCD panel of the present invention can provide a clear and distinct background image with high transparency in a transparent display mode, and provide an image with high color saturation and wide viewing angle in an image display mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pixel structure of a transparent liquid crystal display panel, comprising:
an array substrate;
a pixel, comprising a white sub-pixel and a color sub-pixel, the white sub-pixel consisting of a first alignment region and a second alignment, the first alignment region and the second alignment region of the white sub-pixel having different aligning directions, the color sub-pixel comprising a first alignment region, a second alignment region, a third alignment region and a fourth alignment region, the first alignment region, the second alignment region, the third alignment region and the fourth alignment region of the color sub-pixel having different aligning directions, the first alignment region of the color sub-pixel and the first alignment region of the white sub-pixel have substantially the same aligning direction, the second alignment region of the color sub-pixel and the second alignment region of the white sub-pixel have substantially the same aligning direction, and the third alignment region and the fourth alignment region of the color sub-pixel and the first alignment region and the second alignment region of the white sub-pixel have different aligning directions; and
a plurality of liquid crystal molecules, disposed in the pixel,
wherein in a transparent display mode, the first alignment region and the second alignment region of the white sub-pixel and the first alignment region and the second alignment region of the color sub-pixel have a transparent display grayscale, and the third alignment region and the fourth alignment region of the color sub-pixel have a non-transparent display grayscale, and
wherein in an image display mode, the first alignment region and the second alignment region of the white sub-pixel have the non-transparent display grayscale, and the first alignment region, the second alignment region, the third alignment region and the fourth alignment region of the color sub-pixel have an image display grayscale, respectively, based on an image to be displayed.

2. The pixel structure of the transparent liquid crystal display panel of claim 1, wherein in the transparent display mode, a difference between an azimuth angle of a long axis of the liquid crystal molecules disposed in the first alignment region of the white sub-pixel and an azimuth angle of a long axis of the liquid crystal molecules disposed in the second alignment region of the white sub-pixel is substantially 180 degrees, and a difference between an azimuth angle of a long axis of the liquid crystal molecules disposed in the first alignment region of the color sub-pixel and an azimuth angle of a long axis of the liquid crystal molecules disposed in the second alignment region of the color sub-pixel is substantially 180 degrees, in the image display mode, a difference between the azimuth angle of the long axis of the liquid crystal molecules disposed in the first alignment region of the color sub-pixel and an azimuth angle of a long axis of the liquid crystal molecules disposed in the third alignment region of the color sub-pixel is substantially 90 degrees, a difference between the azimuth angle of the long axis of the liquid crystal molecules disposed in the third alignment region of the color sub-pixel and the azimuth angle of the long axis of the liquid crystal molecules disposed in the second alignment region of the color sub-pixel is substantially 90 degrees, a difference between the azimuth angle of the long axis of the liquid crystal molecules disposed in the second alignment region of the color sub-pixel and an azimuth angle of a long axis of the liquid crystal molecules disposed in the fourth alignment region of the color sub-pixel is substantially 90 degrees, and a difference between the azimuth angle of the long axis of the liquid crystal molecules disposed in the fourth alignment region of the color sub-pixel and the azimuth angle of the long axis of the liquid crystal molecules disposed in the first alignment region of the color sub-pixel is substantially 90 degrees.

3. The pixel structure of the transparent liquid crystal display panel of claim 1, wherein the transparent display grayscale is a maximum grayscale and the non-transparent display grayscale is a zero grayscale.

4. The pixel structure of the transparent liquid crystal display panel of claim 1, wherein the liquid crystal molecules comprise vertically-aligned mode (VA mode) liquid crystal molecules.
